(19) United States
(12) Patent Application Publication
(10) Pub. No.: US 2025/0338236 A1
(43) Pub. Date: Oct. 30, 2025

(54) SYNCHRONIZATION SIGNAL FORWARDING TIMING AND SSB TRANSMISSION POSITIONS FOR NETWORK CONTROLLED REPEATERS (NCR)

(71) Applicant: SHARP KABUSHIKI KAISHA, Sakai City, Osaka (JP)

(72) Inventors: ZHANPING YIN, Vancouver, WA (US); TOMOKI YOSHIMURA, Sakai City, Osaka (JP)

(21) Appl. No.: 18/879,899

(22) PCT Filed: Jun. 15, 2023
(86) PCT No.: PCT/JP2023/022297

§ 371 Date: Dec. 30, 2024

Related U.S. Application Data
(60) Provisional application No. 63/388,192, filed on Jul. 11, 2022.

(51) Int. Cl. H04W 56/00; H04L 1/1607; H04W 16/28

(52) U.S. Cl. CPC H04W 56/0015; H04L 1/1614; H04W 16/28

(57) ABSTRACT

A network controlled repeater (NCR) is described. The NCR may include receiving circuitry configured to detect and receive system information including synchronization signal block (SSB) configuration from a gNodeB (gNB), receive side information with NCR SSB forwarding timing from the gNB, and receive side information on SSB positions for NCR SSB transmissions. The NCR may also include transmitting circuitry configured to determine the SSB positions for NCR SSB transmission, regenerate the SSB with NCR SSB indexes, and transmit the SSBs in the determined SSB positions with corresponding NCR beams, and not transmit in the remaining SSB positions in the synchronization signal (SS) burst set.

### TECHNICAL FIELD

The present disclosure relates generally to communication systems. More specifically, the present disclosure relates to side information for synchronization signaling configuration and transmissions of Network Controlled Repeaters (NCR).

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a network controlled repeater (NCR) comprising: receiving circuitry configured to: detect and receive system information including synchronization signal block (SSB) configuration from a gNodeB (gNB); receive side information with NCR SSB forwarding timing from the gNB; receive side information on SSB positions for NCR SSB transmissions; transmitting circuitry configured to: determine the SSB positions for NCR SSB transmission; regenerate the SSB with NCR SSB indexes; transmit the SSBs in the determined SSB positions with corresponding NCR beams, and not transmit in the remaining SSB positions in the synchronization signal (SS) burst set.

In one example, a gNodeB (gNB) comprising: transmitting circuitry configured to: transmit side information on synchronization signal block (SSB) forwarding timing to a network controlled repeater (NCR); transmit side information on SSB positions for an NCR SSB transmission to the NCR; receiving circuitry configured to: receive a beam report based on an SSB index from a User Equipment (UE); determine an NCR beam index based on the received SSB index from the UE.

In one example, a communication method of a network controlled repeater (NCR), comprising: detecting and receiving system information including synchronization signal block (SSB) configuration from a gNodeB (gNB); receiving side information with an NCR SSB forwarding timing from the gNB; receiving side information on SSB positions for NCR SSB transmissions; determining the SSB positions for NCR SSB transmission; regenerating the SSB with NCR SSB indexes; transmitting the SSBs in the determined SSB positions with corresponding NCR beams, and not transmitting in the remaining SSB positions in the synchronization signal (SS) burst set.

### BRIEF DESCRIPTION OF DRAWINGS

FIG. 1 is a block diagram illustrating one implementation of one or more g Node Bs (gNBs) and one or more user equipment (UEs) in which systems and methods for signaling may be implemented.

FIG. 2 shows examples of multiple numerologies.

FIG. 3 is a diagram illustrating one example of a resource grid and resource block.

FIG. 4 shows examples of resource regions.

FIG. 5 is a block diagram illustrating one implementation of a network controller repeater (NCR).

FIG. 6 is a diagram illustrating one example of a synchronization signal block.

FIG. 7 is a diagram illustrating one example of an SSB (Synchronization Signal Block) burst and an SSB set configuration.

FIG. 8 is a diagram illustrating one example of beam sweeping with an SSB burst.

FIG. 9 is a diagram illustrating one example SSB detection at an NCR and SSB regeneration.

FIG. 10 is a sequence diagram illustrating one example of a procedure of SSB generation and transmission for an NCR.

FIG. 11 is a flow diagram illustrating one example of a method for the NCR behavior associated with the sequence diagram of FIG. 10.

FIG. 12 is a sequence diagram illustrating another example of a procedure of SSB generation and transmission for an NCR.

FIG. 13 is an example of a block diagram of an NCR framework.

FIG. 14 is an example of synchronization signal forwarding timing at an NCR.

FIG. 15 is an example of a diagram illustrating NCR SS burst mapping with local beam indexes.

FIG. 16 is an example of a diagram illustrating NCR SSB transmission by dedicated SSB positions in burst signaling.

FIG. 17 is a diagram showing cyclic beam mapping at an NCR.

FIG. 18 is a diagram showing continuous repetition beam mapping at an NCR.

FIG. 19 illustrates various components that may be utilized in a UE.

FIG. 20 illustrates various components that may be utilized in a gNB.

FIG. 21 illustrates various components that may be utilized in an NCR.

FIG. 22 is a block diagram illustrating one implementation of a UE in which one or more of the systems and/or methods described herein may be implemented.

FIG. 23 is a block diagram illustrating one implementation of a gNB in which one or more of the systems and/or methods described herein may be implemented.

FIG. 24 is a block diagram illustrating one implementation of an NCR in which one or more of the systems and/or methods described herein may be implemented.

FIG. 25 is a block diagram illustrating one implementation of a gNB.

FIG. 26 is a block diagram illustrating one implementation of a UE.

### DESCRIPTION OF EMBODIMENTS

A network controlled repeater (NCR) is described. The NCR may include receiving circuitry configured to detect and receive system information including synchronization signal block (SSB) configuration from a gNodeB (gNB), receive side information with NCR SSB forwarding timing from the gNB, and receive side information on SSB positions for NCR SSB transmissions. The NCR may also include transmitting circuitry configured to determine the SSB positions for NCR SSB transmission, regenerate the SSB with NCR SSB indexes, and transmit the SSBs in the determined SSB positions with corresponding NCR beams, and not transmit in the remaining SSB positions in the synchronization signal (SS) burst set.

The forwarding timing of the NCR may be 5 milliseconds (ms) or it may be provided by the side information with a parameter of a number of slots.

In some examples, the SSB positions for the NCR SSB transmission of the NCR may be determined by the NCR beam indexes. In other examples, the SSB positions for the NCR SSB transmission of the NCR may also be determined by a configured pattern with dedicated SSB positions in burst for NCR, or an on/off bitmap pattern for NCR.

A gNodeB (gNB) is described. The gNB may include transmitting circuitry configured to transmit side information on synchronization signal block (SSB) forwarding timing to a network controlled repeater (NCR) and transmit side information on SSB positions for an NCR SSB transmission to the NCR. The gNB may also include receiving circuitry configured to receive a beam report based on an SSB index from a User Equipment (UE) and determine an NCR beam index based on the received SSB index from the UE.

The side information of the gNB may include a configured pattern with dedicated SSB positions in burst for NCR, or an on/off bitmap pattern for NCR includes a number of beams for the NCR SSB reception.

If the configured pattern with dedicated SSB positions in burst for NCR, or the on/off bitmap pattern for NCR is configured, the gNB may determine the NCR beam index based on the configured pattern.

A communication method of a network controlled repeater (NCR) is described. The communication method may include detecting and receiving system information including synchronization signal block (SSB) configuration from a gNodeB (gNB), receiving side information with an NCR SSB forwarding timing from the gNB, receiving side information on SSB positions for NCR SSB transmissions, determining the SSB positions for NCR SSB transmission, regenerating the SSB with NCR SSB indexes, and transmitting the SSBs in the determined SSB positions with corresponding NCR beams, and not transmitting in the remaining SSB positions in the synchronization signal (SS) burst set.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), LTE-Advanced Pro and other standards (e.g., 3GPP Releases 8, 9, 10, 11, 12, 13, 14, 15, 16, 17, and/or 18). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB), a g Node B (gNB) or some other similar terminology. As the scope of the disclosure should not be limited to 3GPP standards, the terms “base station,” “Node B,” “eNB,” “gNB” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An gNB may also be more generally referred to as a base station device.

It should be noted that as used herein, a “cell” may be any communication channel that is specified by standardization or regulatory bodies to be used for International Mobile Telecommunications-Advanced (IMT-Advanced) or IMT-2020, and all of it or a subset of it may be adopted by 3GPP as licensed bands or unlicensed bands (e.g., frequency bands) to be used for communication between an eNB or gNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra Reliable and Low Latency Communication) transmission, and mMTC (massive Machine Type Communication) transmission. And, in NR, transmissions for different services may be specified (e.g., configured) for one or more bandwidth parts (BWPs) in a serving cell and/or for one or more serving cells. A user equipment (UE) may receive a downlink signal(s) and/or transmit an uplink signal(s) in the BWP(s) of the serving cell and/or the serving cell(s).

In order for the services to use the time, frequency, and/or spatial resources efficiently, it would be useful to be able to efficiently control downlink and/or uplink transmissions. Therefore, a procedure for efficient control of downlink and/or uplink transmissions should be designed. Accordingly, a detailed design of a procedure for downlink and/or uplink transmissions may be beneficial.

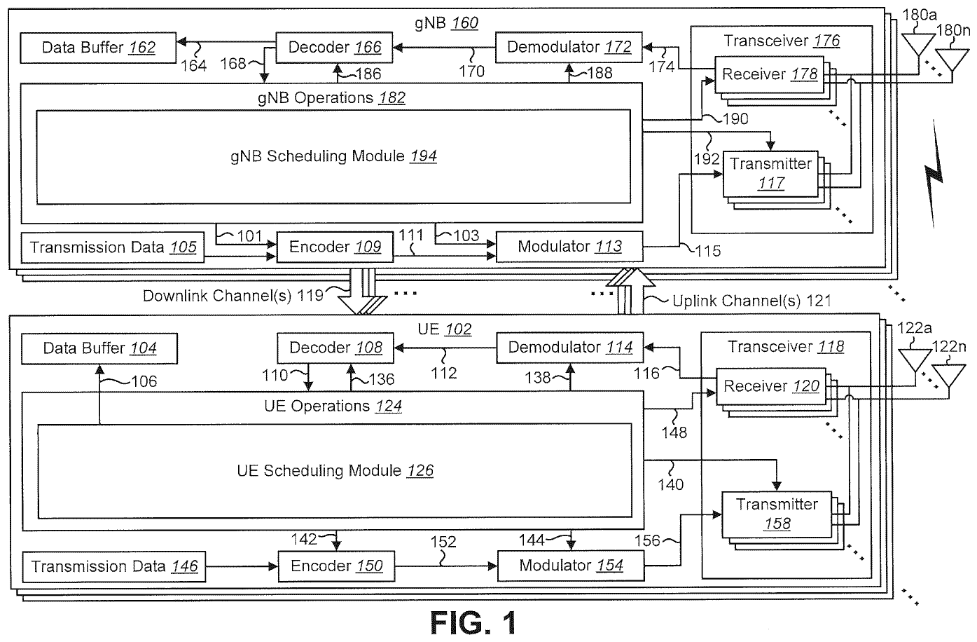

FIG. 1 is a block diagram illustrating one implementation of one or more gNBs 160 and one or more UEs 102 in which systems and methods for signaling may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n. In some implementations, the term “base station,” “eNB,” and/or “gNB” may refer to and/or may be replaced by the term “Transmission Reception Point (TRP).” For example, the gNB 160 described in connection with FIG. 1 may be a TRP in some implementations.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (physical uplink shared channel)) and/or a physical control channel (e.g., PUCCH (physical uplink control channel)), etc. The one or more gNBs 160 may also transmit information or data to the one or more UEs 102 using one or more downlink channels 119, for instance. Examples of downlink channels 119 include a physical shared channel (e.g., PDSCH (physical downlink shared channel) and/or a physical control channel (PDCCH (physical downlink control channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE scheduling module 126.

The UE scheduling module 126 may perform downlink reception(s) and uplink transmission(s). The downlink reception(s) include reception of data, reception of downlink control information, and/or reception of downlink reference signals. Also, the uplink transmissions include transmission of data, transmission of uplink control information, and/or transmission of uplink reference signals.

Also, in a carrier aggregation (CA), the gNB 160 and the UE 102 may communicate with each other using a set of serving cells. Here a set of serving cells may include one primary cell and one or more secondary cells. For example, the gNB 160 may transmit, by using the RRC message, information used for configuring one or more secondary cells to form together with the primary cell a set of serving cells. Namely, the set of serving cells may include one primary cell and one or more secondary cells. Here, the primary cell may be always activated. Also, the gNB 160 may activate zero or more secondary cell within the configured secondary cells. Here, in the downlink, a carrier corresponding to the primary cell may be the downlink primary component carrier (i.e., the DL PCC), and a carrier corresponding to a secondary cell may be the downlink secondary component carrier (i.e., the DL SCC). Also, in the uplink, a carrier corresponding to the primary cell may be the uplink primary component carrier (i.e., the UL PCC), and a carrier corresponding to the secondary cell may be the uplink secondary component carrier (i.e., the UL SCC).

Also, in a single cell operation, the gNB 160 and the UE 102 may communicate with each other using one serving cell. Here, the serving cell may be a primary cell.

In a radio communication system, physical channels (uplink physical channels and/or downlink physical channels) may be defined. The physical channels (uplink physical channels and/or downlink physical channels) may be used for transmitting information that is delivered from a higher layer and/or information that is generated from a physical layer.

### PRACH

For example, in uplink, a PRACH (Physical Random Access Channel) may be defined. In some approaches, the PRACH (e.g., as part of a random access procedure) may be used for an initial access connection establishment procedure, a handover procedure, a connection re-establishment, a timing adjustment (e.g., a synchronization for an uplink transmission, for UL synchronization) and/or for requesting an uplink shared channel (UL-SCH) resource (e.g., the uplink physical shared channel (PSCH) (e.g., PUSCH) resource).

### PUCCH

In another example, a physical uplink control channel (PUCCH) may be defined. The PUCCH may be used for transmitting uplink control information (UCI). The UCI may include hybrid automatic repeat request-acknowledgement (HARQ-ACK), channel state information (CSI) and/or a scheduling request (SR). The HARQ-ACK is used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI is used for indicating state of downlink channel (e.g., a downlink signal(s)). Also, the SR is used for requesting resources of uplink data (e.g., Transport block(s), MAC PDU and/or Uplink Shared Channel (UL-SCH)).

Here, the DL-SCH and/or the UL-SCH may be a transport channel that is used in the MAC layer. Also, a transport block(s) (TB(s)) and/or a MAC PDU may be defined as a unit(s) of the transport channel used in the MAC layer. The transport block may be defined as a unit of data delivered from the MAC layer to the physical layer. The MAC layer may deliver the transport block to the physical layer (e.g., the MAC layer delivers the data as the transport block to the physical layer). In the physical layer, the transport block may be mapped to one or more codewords.

### PDCCH

In downlink, a physical downlink control channel (PDCCH) may be defined. The PDCCH may be used for transmitting downlink control information (DCI). Here, more than one DCI formats may be defined for DCI transmission on the PDCCH. Namely, fields may be defined in the DCI format(s), and the fields are mapped to the information bits (e.g., DCI bits).

### PDSCH and PUSCH

A physical downlink shared channel (PDSCH) and a physical uplink shared channel (PUSCH) may be defined. For example, in a case that the PDSCH (e.g., the PDSCH resource) is scheduled by using the DCI format(s) for the downlink, the UE 102 may receive the downlink data, on the scheduled PDSCH (e.g., the PDSCH resource). Alternatively, in a case that the PUSCH (e.g., the PUSCH resource) is scheduled by using the DCI format(s) for the uplink, the UE 102 transmits the uplink data, on the scheduled PUSCH (e.g., the PUSCH resource). For example, the PDSCH may be used to transmit the downlink data (e.g., DL-SCH(s), a downlink transport block(s)). Additionally or alternatively, the PUSCH may be used to transmit the uplink data (e.g., UL-SCH(s), an uplink transport block(s)).

Furthermore, the PDSCH and/or the PUSCH may be used to transmit information of a higher layer (e.g., a radio resource control (RRC)) layer, and/or a MAC layer). For example, the PDSCH (e.g., from the gNB 160 to the UE 102) and/or the PUSCH (e.g., from the UE 102 to the gNB 160) may be used to transmit a RRC message (a RRC signal). Additionally or alternatively, the PDSCH (e.g., from the gNB 160 to the UE 102) and/or the PUSCH (e.g., from the UE 102 to the gNB 160) may be used to transmit a MAC control element (a MAC CE). Here, the RRC message and/or the MAC CE are also referred to as a higher layer signal.

### SS/PBCH Block

In some approaches, a physical broadcast channel (PBCH) may be defined. For example, the PBCH may be used for broadcasting the MIB (master information block). Here, system information may be divided into the MIB and a number of SIB(s) (system information block(s)). For example, the MIB may be used for carrying minimum system information. Additionally or alternatively, the SIB(s) may be used for carrying system information messages.

In some approaches, in downlink, synchronization signals (SSs) may be defined. The SS may be used for acquiring time and/or frequency synchronization with a cell. Additionally or alternatively, the SS may be used for detecting a physical layer cell ID of the cell. SSs may include a primary SS and a secondary SS.

An SS/PBCH block may be defined as a set of a primary SS (PSS), a secondary SS (SSS) and a PBCH. In the time domain, the SS/PBCH block consists of 4 OFDM symbols, numbered in terms of OFDM symbols in increasing order from 0 to 3 within the SS/PBCH block, where PSS, SSS, and PBCH with associated demodulation reference signal (DMRS) are mapped to symbols. One or more SS/PBCH blocks may be mapped within a certain time duration (e.g. 5 msec).

Additionally, the SS/PBCH block may be used for beam measurement, radio resource management (RRM) measurement and radio link monitoring (RLM) measurement. Specifically, the secondary synchronization signal (SSS) may be used for the measurement.

In the radio communication for uplink, UL RS(s) may be used as uplink physical signal(s). Additionally or alternatively, in the radio communication for downlink, DL RS(s) may be used as downlink physical signal(s). The uplink physical signal(s) and/or the downlink physical signal(s) may not be used to transmit information that is provided from the higher layer where the information is used by a physical layer.

Here, the downlink physical channel(s) and/or the downlink physical signal(s) described herein may be assumed to be included in a downlink signal (e.g., a DL signal(s)) in some implementations for the sake of simple descriptions. Additionally or alternatively, the uplink physical channel(s) and/or the uplink physical signal(s) described herein may be assumed to be included in an uplink signal (i.e. an UL signal(s)) in some implementations for the sake of simple descriptions.

### Numerology and Slot Configuration

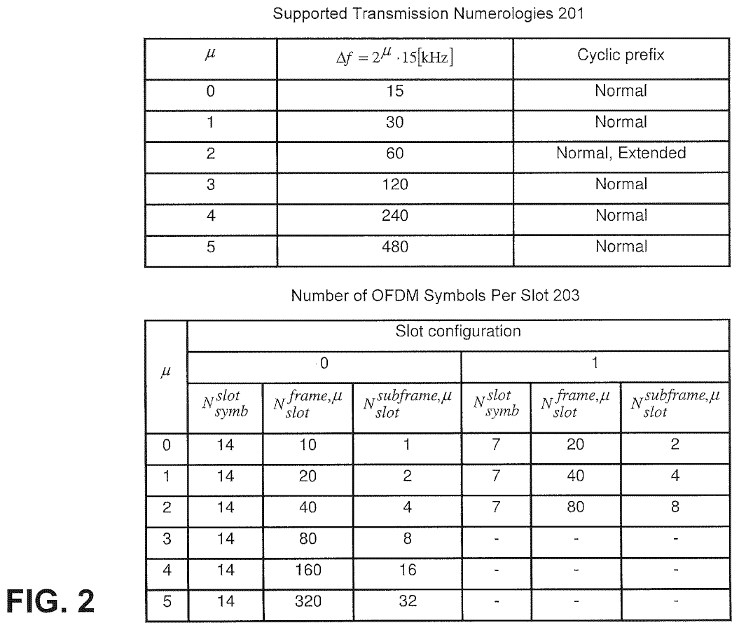

FIG. 2 shows examples of multiple numerologies 201. As shown in FIG. 2, multiple numerologies 201 (e.g., multiple subcarrier spacing) may be supported. For example, u (e.g., a subcarrier space configuration) and a cyclic prefix (e.g., the u and the cyclic prefix for a BWP) may be configured by higher layer parameters (e.g., a RRC message) for the downlink and/or the uplink. Here, 15 kHz may be a reference numerology 201. For example, an RE of the reference numerology 201 may be defined with a subcarrier spacing of 15 kHz in a frequency domain and 2048 Ts+CP length (e.g., 160 Ts or 144 Ts) in a time domain, where Ts denotes a baseband sampling time unit defined as 1/(15000*2048) seconds.

Further, time unit T_{c} may be used for expression of the length of the time domain. For the time unit T_{c}, T_{c}=1/(Δfₘₐₓ·N_{f}) where Δfₘₐₓ=480 kHz and N_{f}=4096. For a constant κ, κ=Δfₘₐₓ·N_{f}/(Δf_{ref}N_{f,ref})=64. Δf_{ref} is 15 kHz. N_{f,ref} is 2048.
Transmission of a signal in the downlink and/or transmission of a signal in the uplink may be organized into a radio frame having the length T_{f}. T_{f}=(ΔfₘₐₓN_{f}/100). Tₛ=10 ms. Here, “·” represents multiplication. The radio frame includes 10 subframes. For the length T_{sf} of the subframe, T_{sf}=(ΔfₘₐₓN_{f}/1000). Tₛ=1 ms. For the number of OFDM symbols per subframe, N^{subframe,μ}_{symb}=N^{slot}_{symb}N^{subframe,μ}ₛₗₒₜ. Additionally or alternatively, a number of OFDM symbol(s) 203 per slot

$$( {N}_{symb}^{slot} )$$

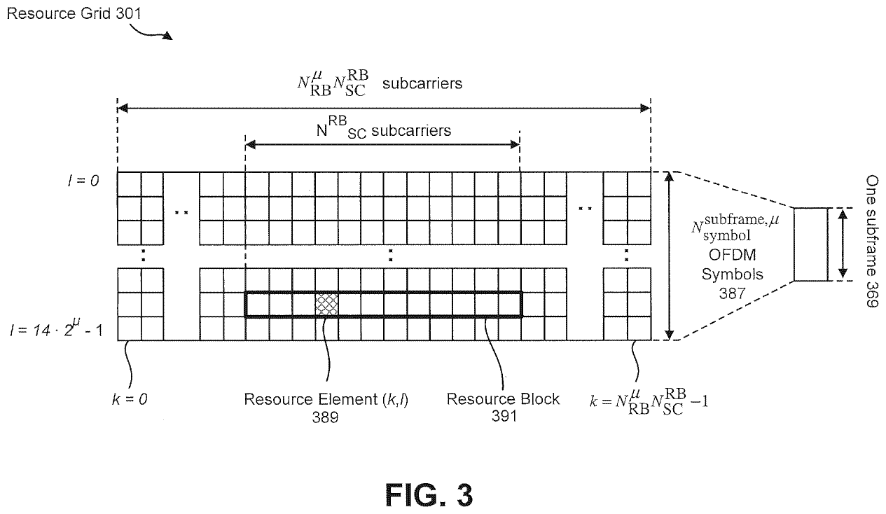

may be determined based on the μ (e.g., the subcarrier space configuration).
FIG. 3 is a diagram illustrating one example of a resource grid 301 and resource block 391 (e.g., for the downlink and/or the uplink). The resource grid 301 and resource block 391 illustrated in FIG. 3 may be utilized in some implementations of the systems and methods disclosed herein. In another example, the resource block 391 may include N^{RB}_{sc} continuous subcarriers. In another example, the resource block 391 may consists of N^{RB}_{sc} continuous subcarriers.

In FIG. 3, one subframe 369 may include

$${N}_{symbol}^{subframe , μ}$$

symbols 387. Additionally or alternatively, a resource block 391 may include a number of resource elements (RE) 389. Here, in the downlink, the OFDM access scheme with cyclic prefix (CP) may be employed, which may be also referred to as CP-OFDM. A downlink radio frame may include multiple pairs of downlink resource blocks (RBs) 391 which is also referred to as physical resource blocks (PRBs). The downlink RB pair is a unit for assigning downlink radio resources, defined by a predetermined bandwidth (RB bandwidth) and a time slot. The downlink RB pair may include two downlink RBs 391 that are continuous in the time domain. Additionally or alternatively, the downlink RB 391 may include twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) 389 and is uniquely identified by the index pair (k,l), where k and/are indices in the frequency and time domains, respectively.

Additionally or alternatively, in the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). An uplink radio frame may include multiple pairs of uplink resource blocks 391. The uplink RB pair is a unit for assigning uplink radio resources, defined by a predetermined bandwidth (RB bandwidth) and a time slot. The uplink RB pair may include two uplink RBs 391 that are continuous in the time domain. The uplink RB may include twelve sub-carriers in frequency domain and seven (for normal CP) or six (for extended CP) OFDM/DFT-S-OFDM symbols in time domain. A region defined by one sub-carrier in the frequency domain and one OFDM/DFT-S-OFDM symbol in the time domain is referred to as a resource element (RE) 389 and is uniquely identified by the index pair (k,l) in a slot, where k and l are indices in the frequency and time domains respectively.

Each element in the resource grid 301 on antenna port p and the subcarrier configuration μ is called a resource element 389 and is uniquely identified by the index pair (k,l) where k=0, . . . ,

$${N}_{RB}^{μ} {N}_{SC}^{RB} - 1$$

is the index in the frequency domain and l refers to the symbol position in the time domain. The resource element (k,l) 389 on the antenna port p and the subcarrier spacing configuration μ is denoted (k,l)_{p,μ}. The physical resource block 391 is defined as

$${N}_{SC}^{RB} = 12$$

consecutive subcarriers in the frequency domain. The physical resource blocks 391 are numbered from 0 to

$${N}_{RB}^{μ} - 1$$

in the frequency domain. The relation between the physical resource block number ⁿPRB in the frequency domain and the resource element (k,l) is given by

$${n}_{PRB} = ⌊ \frac{k}{{N}_{SC}^{RB}} ⌋ .$$

### Reference Signal

In the NR, the following reference signals may be defined
NZP CSI-RS (non-zero power channel state information reference signal)
ZP CSI-RS (Zero-power channel state information reference signal)
DMRS (demodulation reference signal)
SRS (sounding reference signal)
NZP CSI-RS may be used for channel tracking (e.g. synchronization), measurement to obtain CSI (CSI measurement including channel measurement and interference measurement), measurement to obtain the beam forming performance. NZP CSI-RS may be transmitted in the downlink (gNB to UE). NZP CSI-RS may be transmitted in an aperiodic or semi-persistent or periodic manner. Additionally, the NZP CSI-RS can be used for radio resource management (RRM) measurement and radio link control (RLM) measurement.

ZP CSI-RS may be used for interference measurement and transmitted in the downlink (gNB to UE). ZP CSI-RS may be transmitted in an aperiodic or semipersistent or periodic manner.

DMRS may be used for demodulation for the downlink (gNB to UE), the uplink (UE to gNB), and the sidelink (UE to UE).

SRS may be used for channel sounding and beam management. The SRS may be transmitted in the uplink (UE to gNB).

### DCI Format

In some approaches, the DCI may be used. The following DCI formats may be defined
DCI format 0_0
DCI format 0_1
DCI format 0_2
DCI format 1_0
DCI format 1_1
DCI format 1_2
DCI format 2_0
DCI format 2_1
DCI format 2_2
DCI format 2_3
DCI format 2_4
DCI format 2_5
DCI format 2_6
DCI format 3_0
DCI format 3_1

DCI format 0_0 may be used for the scheduling of PUSCH in one cell. The DCI may be transmitted by means of the DCI format 0_0 with cyclic redundancy check (CRC) scrambled by Cell Radio Network Temporary Identifiers (C-RNTI) or Configured Scheduling RNTI (CS-RNTI) or Modulation and Coding Scheme-Cell RNTI (MCS-C-RNTI) or temporally cell RNTI (TC-RNTI).

DCI format 0_1 may be used for the scheduling of one or multiple PUSCH in one cell, or indicating configured grant downlink feedback information (CG-DFI) to a UE. The DCI may be transmitted by means of the DCI format 0_1 with CRC scrambled by C-RNTI or CS-RNTI or semi-persistent channel state information (SP-CSI-RNTI) or MCS-C-RNTI. The DCI format 0_2 may be used for CSI request (e.g. aperiodic CSI reporting or semi-persistent CSI request). The DCI format 0_2 may be used for SRS request (e.g. aperiodic SRS transmission).

DCI format 0_2 may be used for the scheduling of PUSCH in one cell. The DCI may be transmitted by means of the DCI format 0_2 with CRC scrambled by C-RNTI or CS-RNTI or SP-CSI-RNTI or MCS-C-RNTI. The DCI format 0_2 may be used for scheduling of PUSCH with high priority and/or low latency (e.g. URLLC). The DCI format 0_2 may be used for CSI request (e.g. aperiodic CSI reporting or semipersistent CSI request). The DCI format 0_2 may be used for SRS request (e.g. aperiodic SRS transmission).

Additionally, for example, the DCI included in the DCI format 0_Y (Y=0, 1, 2, . . . ) may be a BWP indicator (e.g., for the PUSCH). Additionally or alternatively, the DCI included in the DCI format 0_Y may be a frequency domain resource assignment (e.g., for the PUSCH). Additionally or alternatively, the DCI included in the DCI format 0_Y may be a time domain resource assignment (e.g., for the PUSCH). Additionally or alternatively, the DCI included in the DCI format 0_Y may be a modulation and coding scheme (e.g., for the PUSCH). Additionally or alternatively, the DCI included in the DCI format 0_Y may be a new data indicator. Additionally or alternatively, the DCI included in the DCI format 0_Y may be a TPC command for scheduled PUSCH. Additionally or alternatively, the DCI included in the DCI format 0_Y may be a CSI request that is used for requesting the CSI reporting. Additionally or alternatively, as described below, the DCI included in the DCI format 0_Y may be information used for indicating an index of a configuration of a configured grant. Additionally or alternatively, the DCI included in the DCI format 0_Y may be the priority indication (e.g., for the PUSCH transmission and/or for the PUSCH reception).

DCI format 1_0 may be used for the scheduling of PDSCH in one DL cell. The DCI is transmitted by means of the DCI format 1_0 with CRC scrambled by C-RNTI or CS-RNTI or MCS-C-RNTI. The DCI format 1_0 may be used for random access procedure initiated by a PDCCH order. Additionally or alternately, the DCI may be transmitted by means of the DCI format 1_0 with CRC scrambled by system information RNTI (SI-RNTI), and the DCI may be used for system information transmission and/or reception. Additionally or alternately, the DCI may be transmitted by means of the DCI format 1_0 with CRC scrambled by random access RNTI (RA-RNTI) for random access response (RAR) (e.g. Msg 2) or msgB-RNTI for 2-step RACH. Additionally or alternately, the DCI may be transmitted by means of the DCI format 1_0 with CRC scrambled by temporally cell RNTI (TC-RNTI), and the DCI may be used for msg3 transmission by a UE 102.

DCI format 1_1 may be used for the scheduling of PDSCH in one cell. The DCI may be transmitted by means of the DCI format 1_1 with CRC scrambled by C-RNTI or CS-RNTI or MCS-C-RNTI. The DCI format 1_1 may be used for SRS request (e.g. aperiodic SRS transmission).

DCI format 1_2 may be used for the scheduling of PDSCH in one cell. The DCI may be transmitted by means of the DCI format 1_2 with CRC scrambled by C-RNTI or CS-RNTI or SP-CSI-RNTI or MCS-C-RNTI. The DCI format 1_2 may be used for scheduling of PDSCH with high priority and/or low latency (e.g. URLLC). The DCI format 1_2 may be used for SRS request (e.g. aperiodic SRS transmission).

Additionally, for example, the DCI included in the DCI format 1_X may be a BWP indicator (e.g., for the PDSCH). Additionally or alternatively, the DCI included in the DCI format 1_X may be frequency domain resource assignment (e.g., for the PDSCH). Additionally or alternatively, the DCI included in the DCI format 1_X may be a time domain resource assignment (e.g., for the PDSCH). Additionally or alternatively, the DCI included in the DCI format 1_X may be a modulation and coding scheme (e.g., for the PDSCH). Additionally or alternatively, the DCI included in the DCI format 1_X may be a new data indicator. Additionally or alternatively, the DCI included in the DCI format 1_X may be a TPC command for scheduled PUCCH. Additionally or alternatively, the DCI included in the DCI format 1_X may be a CSI request that is used for requesting (e.g., triggering) transmission of the CSI (e.g., CSI reporting (e.g., aperiodic CSI reporting)). Additionally or alternatively, the DCI included in the DCI format 1_X may be a PUCCH resource indicator. Additionally or alternatively, the DCI included in the DCI format 1_X may be a PDSCH-to-HARQ feedback timing indicator. Additionally or alternatively, the DCI included in the DCI format 1_X may be the priority indication (e.g., for the PDSCH transmission and/or the PDSCH reception). Additionally or alternatively, the DCI included in the DCI format 1_X may be the priority indication (e.g., for the HARQ-ACK transmission for the PDSCH and/or the HARQ-ACK reception for the PDSCH).

DCI format 2_0 may be used for notifying the slot format, channel occupancy time (COT) duration for unlicensed band operation, available resource block (RB) set, and search space group switching. The DCI may transmitted by means of the DCI format 2_0 with CRC scrambled by slot format indicator RNTI (SFI-RNTI).

DCI format 2_1 may used for notifying the physical resource block(s) (PRB(s)) and orthogonal frequency division multiplexing (OFDM) symbol(s) where UE may assume no transmission is intended for the UE. The DCI is transmitted by means of the DCI format 2_1 with CRC scrambled by interrupted transmission RNTI (INT-RNTI).

DCI format 2_2 may used for the transmission of transmission power control (TPC) commands for PUCCH and PUSCH. The following information is transmitted by means of the DCI format 2_2 with CRC scrambled by TPC-PUSCH-RNTI or TPC-PUCCH-RNTI. In a case that the CRC is scrambled by TPC-PUSCH-RNTI, the indicated one or more TPC commands may applied to the TPC loop for PUSCHs. In a case that the CRC is scrambled by TPC-PUCCH-RNTI, the indicated one or more TPC commands may be applied to the TPC loop for PUCCHs.

DCI format 2_3 may be used for the transmission of a group of TPC commands for SRS transmissions by one or more UEs. Along with a TPC command, a SRS request may also be transmitted. The DCI may be is transmitted by means of the DCI format 2_3 with CRC scrambled by TPC-SRS-RNTI.

DCI format 2_4 may used for notifying the PRB(s) and OFDM symbol(s) where UE cancels the corresponding UL transmission. The DCI may be transmitted by means of the DCI format 2_4 with CRC scrambled by cancellation indication RNTI (CI-RNTI).

DCI format 2_5 may used for notifying the availability of soft resources for integrated access and backhaul (IAB) operation. The DCI may be transmitted by means of the DCI format 2_5 with CRC scrambled by availability indication RNTI (AI-RNTI).

DCI format 2_6 may used for notifying the power saving information outside discontinuous reception (DRX) Active Time for one or more UEs. The DCI may transmitted by means of the DCI format 2_6 with CRC scrambled by power saving RNTI (PS-RNTI).

DCI format 3_0 may used for scheduling of NR physical sidelink control channel (PSCCH) and NR physical sidelink shared channel (PSSCH) in one cell. The DCI may be transmitted by means of the DCI format 3_0 with CRC scrambled by sidelink RNTI (SL-RNTI) or sidelink configured scheduling RNTI (SL-CS-RNTI). This may be used for vehicular to everything (V2X) operation for NR V2X UE(s).

DCI format 3_1 may be used for scheduling of LTE PSCCH and LTE PSSCH in one cell. The following information is transmitted by means of the DCI format 3_1 with CRC scrambled by SL-L-CS-RNTI. This may be used for LTE V2X operation for LTE V2X UE(s).

### Search Space

The UE 102 may monitor one or more DCI formats on common search space set (CSS) and/or UE-specific search space set (USS). A set of PDCCH candidates for a UE to monitor may be defined in terms of PDCCH search space sets. A search space set can be a CSS set or a USS set. A UE 102 monitors PDCCH candidates in one or more of the following search spaces sets. The search space may be defined by a PDCCH configuration in a RRC layer.
a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG
a Type0A-PDCCH CSS set configured by searchSpaceOtherSystemInformation in PDCCH-ConfigCommon for a DCI format with CRC scrambled by a SI-RNTI on the primary cell of the MCG
a Type1-PDCCH CSS set configured by ra-SearchSpace in PDCCH-ConfigCommon for a DCI format with CRC scrambled by a RA-RNTI or a TC-RNTI on the primary cell
a Type2-PDCCH CSS set configured by pagingSearchSpace in PDCCH-ConfigCommon for a DCI format with CRC scrambled by a P-RNTI on the primary cell of the MCG
a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, only for the primary cell, C-RNTI, MCS-C-RNTI, or CS-RNTI(s), and
a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

The UE 102 may monitor a set of candidates of the PDCCH in one or more control resource sets (e.g., CORESETs) on the active DL bandwidth part (BWP) on each activated serving cell according to corresponding search space sets. The CORESETs may be configured from gNB 160 to a UE 102, and the CSS set(s) and the USS set(s) are defined in the configured CORESET. One or more CORESET may be configured in a RRC layer.

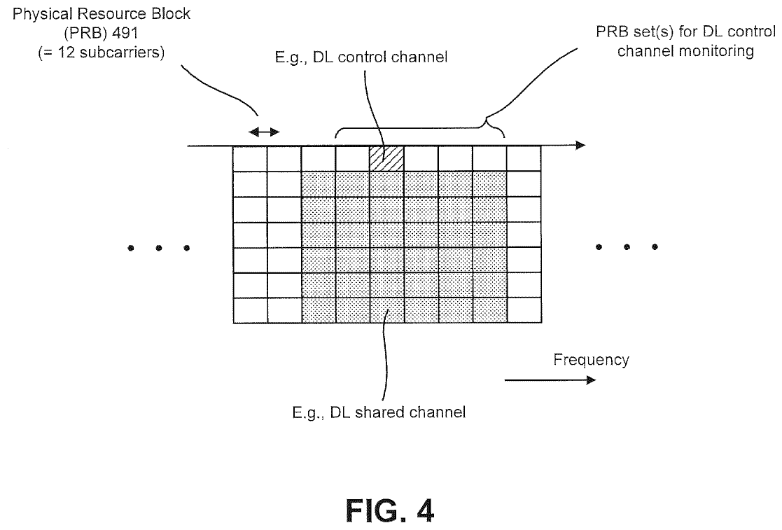

FIG. 4 shows examples of resource regions (e.g., resource region of the downlink). One or more sets 401 of PRB(s) 491 (e.g., a control resource set (e.g., CORESET)) may be configured for DL control channel monitoring (e.g., the PDCCH monitoring). For example, the CORESET is, in the frequency domain and/or the time domain, a set 401 of PRBs 491 within which the UE 102 attempts to decode the DCI (e.g., the DCI format(s), the PDCCH(s)), where the PRBs 491 may or may not be frequency contiguous and/or time contiguous, a UE 102 may be configured with one or more control resource sets (e.g., the CORESETs) and one DCI message may be mapped within one control resource set. In the frequency-domain, a PRB 491 is the resource unit size (which may or may not include DM-RS) for the DL control channel.

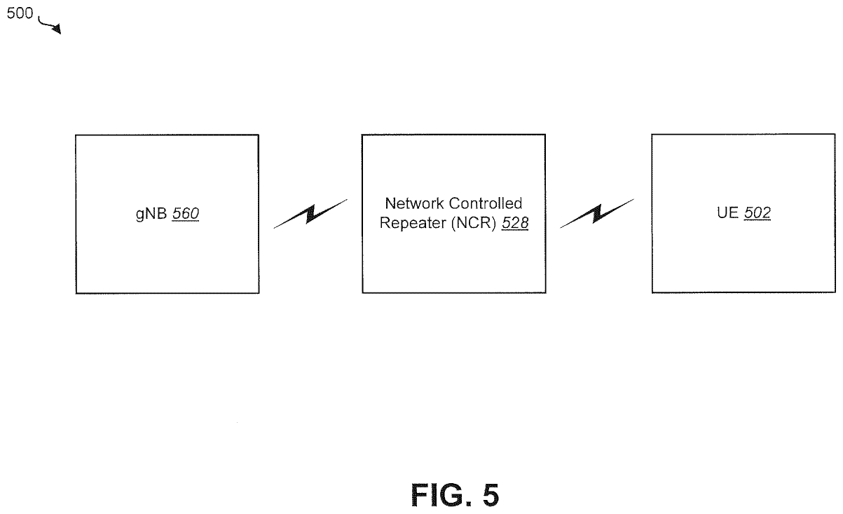

FIG. 5 is a block diagram illustrating one implementation 500 of a network controller repeater (NCR) 528. A network controlled repeater (NCR) 528, or a smart repeater can enhance the physical signaling forwarding with proper beams based on the locations of the gNB 560 and the connected UEs 502.

Due to different locations and directions from the gNB 560 to the NCR 528, and the NCR 528 to a connected UE 502, the beams between the gNB 560 and NCR 528 can be very different from the beams from NCR 528 to a UE 502. Therefore, how to configure the synchronization signals for proper beam management should be decided first.

Currently, a physical layer relay performs amplify-and-forward on received signals without knowing the target destinations and the contents of the signals. Thus, it cannot perform beam-based transmissions to the target UE 502. On the other hand, an Integrated Access and Backhaul (IAB) node works as an gNB 560 to UE 502 and as a UE 502 to gNB 560. So, the data is decoded and rescheduled and forwarded from one side to the other side.

An NCR 528 based transmission with beamforming cannot be achieved by some systems.

An NCR node can perform separate beam management for the link between the gNB 560 and NCR 528, and the link between the NCR 528 and UE 502. To perform beam management between NCR 528 and UEs 502, the NCR 528 should regenerate and transmit synchronization signals based on the received synchronization information from gNB 560.

For the link between NCR 528 and gNB 560, the gNB 560 configures SSBs with beam sweeping, the NCR 528 may determine the best beam between the NCR 528 and gNB 560 with existing beam management methods.

The NCR 528 may then detect the SSBs and PBCHs, and regenerate the SSBs and PBCHs with the detected information. The NCR 528 then transmits the synchronization signals with sperate beams and SSB burst structures based on some higher layer configurations.

The NCR 528 should decode and regenerate the SSBs with different beams in different SSB instances in a SSB burst. The SSB and PBCH information can be the same as detected in the SSBs and PBCHs transmitted by the gNB 560. Additionally or alternatively, the SSBs and PBCHs can include extra NCR specific parameters besides the information from the gNB 560, or with information provided by gNBs via higher layer signaling.

For the SSB burst and beam configuration, the NCR 528 may obtain configurations from gNB 560 to decide the number of SSBs in a burst and the beams associated with the SSB transmissions. Alternatively, the NCR 528 may decide the number of SSBs in a burst and the beams associated with the SSB transmissions locally, and report the configurations to gNB 560 automatically or upon request.

In the description below, the detailed signaling/configuration and NCR 528 SSB transmissions are discussed.

In one method, the NCR 528 can be configured with a separate synchronization signal structure by side information from the gNB 560. The NCR 528 may also receive NCR specific MIB and/or SIB from the gNB 560. The NCR 528 re-generates synchronization signals with the updated information, and transmits the SSBs with local NCR beams following the configured SSB burst structure.

In another method, the gNB 560 synchronization signal configuration is maintained by NCR SSB transmissions. The NCR 528 first determines a forward timing or delay, then transmit regenerated SSBs with local NCR beams. If the number of NCR beams is smaller than the number of beams at the gNB 560, in one approach, one-to-one mapping is performed between the SSB transmission and the NCR beam within the gNB SSB burst set; in another approach, multiple-to-one mapping is allowed to transmit multiple SSBs with the same NCR beam.

Coverage is a fundamental aspect of cellular network deployments. Mobile operators rely on different types of network nodes to offer blanket coverage in their deployments. Deployment of regular full-stack cells is one option but it may not be always possible (e.g., no availability of backhaul) or economically viable.

As a result, new types of network nodes have been considered to increase mobile operators' flexibility for their network deployments. For example, Integrated Access and Backhaul (IAB) was introduced in Rel-16 and enhanced in Rel-17 as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells. In Rel-17, RAN4 specified RF and EMC requirements for such RF repeaters for NR targeting both FR1 and FR2.

While an RF repeater presents a cost effective means of extending network coverage, it has its limitations. An RF repeater simply does an amplify-and-forward operation without being able to take into account various factors that could improve performance. Such factors may include information on semi-static and/or dynamic downlink/uplink configuration, adaptive transmitter/receiver spatial beamforming, ON-OFF status, etc.

A network-controlled repeater (NCR) is an enhancement over conventional RF repeaters with the capability to receive and process side control information from the network. Side control information could allow a network-controlled repeater to perform its amplify-and-forward operation in a more efficient manner. Potential benefits could include mitigation of unnecessary noise amplification, transmissions and receptions with better spatial directivity, and simplified network integration.

The study on NR network-controlled repeaters may consider the following scenarios and assumptions:
Network-controlled repeaters are inband RF repeaters used for extension of network coverage on FR1 and FR2 bands, while during the study FR2 deployments may be prioritized.
For only single hop stationary network-controlled repeaters
Network-controlled repeaters are transparent to UEs
Network-controlled repeater can maintain the gNB-repeater link and repeater-UE link simultaneously

Cost efficiency may be a consideration point for network-controlled repeaters (NCRs).

Some side control information below may be considered relating to network-controlled repeaters including assumption of max transmission power:
Beamforming information
Timing information to align transmission/reception boundaries of network-controlled repeater
Information on UL-DL TDD configuration
ON-OFF information for efficient interference management and improved energy efficiency
Power control information for efficient interference management (as the 2nd priority)
   Further consideration may be given to L1/L2 signaling (including its configuration) to carry the side control information.

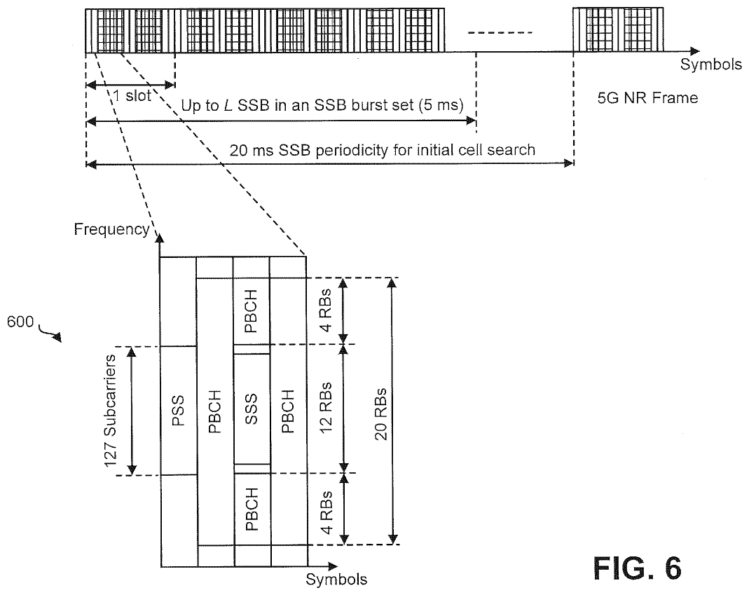

FIG. 6 demonstrates a synchronization signal block (SSB) 600 in NR. Synchronization signal block (SSB) refers to Synchronization/PBCH block because synchronization signal and PBCH channel are packed as a single block that moves together. The components of this block include:
Synchronization Signal: PSS (Primary Synchronization Signal), SSS (Secondary Synchronization Signal)
PBCH: PBCH DMRS and PBCH (Data)

5G NR resource grid consists of subcarriers in frequency domain and symbols in time domain. Resource grid is combination of resource blocks (RBs). One RB (resource Block) consists of 12 consecutive subcarriers in frequency domain. There two frequency bands supported in 5G NR technology, i.e. FR1 (Sub-6 GHz) and FR2 (millimeter wave). There are various subcarrier spacing supported in 5G NR with 15 KHz, 30 KHz, 60 KHz, 120 KHz and 240 KHz. SSB utilizes subcarrier spacing of 15 or 30 KHz in FR1 and 120 or 240 KHz in FR2. FIG. 6 is a diagram illustrating one example of a synchronization signal block.

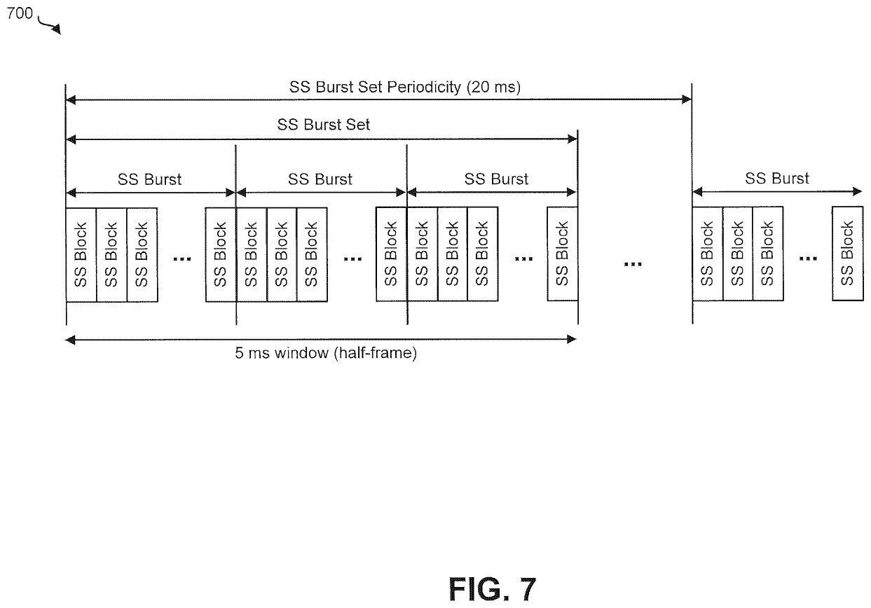

FIG. 7 is a diagram 700 illustrating one example of an SSB (Synchronization Signal Block) burst and an SSB set configuration.
SS Block: {1 symbol PSS, 1 symbol SSS, 2 symbols PBCH}
SS Burst: One or multiple SS Block(s)
SS Burst Set: One or multiple SS burst(s), Transmission periodic (default: 20 ms), Confined in 5 ms window

As shown, SSB is mapped to 4 OFDM symbols in the time domain versus 20 resource blocks (RBs), i.e., 240 subcarriers in the frequency domain. Beam sweeping concept is employed in 5G NR for SSB transmission. Multiple SSBs are transmitted periodically at about 20 ms intervals. About 64 SSBs are transmitted in different beams within SS burst set period. SS blocks transmission within single SS burst set is limited to about 5 ms window. Frequency location of SSB is configured by upper layer stack to support sparser search raster in order to detect SSB.

Following are the possible candidate SSB locations (L) within SS Burst Set. Each slot in time domain consists of 2 SS block locations for <6 GHz for 15 KHz/30 KHz. Each slot consists of 2 SS blocks in 120 KHz for >6 GHz.

How many different beams are being transmitted is determined by how many SSBs are being transmitted within a SSB Burst Set (a set of SSBs being transmitted in 5 ms window of SSB transmission). The Lmax is the parameter defining the maximum number of SSBs that can be transmitted within a SSB set. In sub 6 GHz, up to 3 GHZ, then Lmax is, or from 3 GHz up to 6 GHZ, then Lmax is 8 And in millimeter wave (mmWave) from 6 GHz to 52.6 GHz, then Lmax is 64. In other words, in sub 6 GHz, a maximum of 4 or 8 different beams can be used and they sweep in one dimension (horizontal only or vertical only). in mmWave, a maximum of 64 different beams can be used and they can sweep in two dimensions (horizontal and vertical directions). Note the actual number of SSBs L within SS Burst Set is configured by gNB and the value of L is smaller or equal to Lmax.

The candidate SS/PBCH blocks in a half frame (e.g, 5 ms window in FIG. 7) are indexed in an ascending order in time from 0 to L−1.

A UE determines the 2 LSB bits, for L=4, or the 3 LSB bits, for L>4, of a SS/PBCH block index per half frame from a one-to-one mapping with an index of the DM-RS sequence transmitted in the PBCH. For L=64, the UE determines the 3 MSB bits of the SS/PBCH block index per half frame by PBCH payload bits. Thus, each SS Block within a SS Block Set (i.e., all of the SS Blocks within the 5 ms period of the SSB transmission) is assigned with a unique number starting from 0 and increasing by 1 from 0 to L−1. This unique number resets to 0 in the next SS Block Set (i.e., next 5 ms span after SSB transmission cycle (e.g., 20 ms). This unique number (i.e., SSBlock Index) is informed to UE via two different parts within SSBlock.
One part is carried by PBCH DMRS (i.e., SSB parameter).
Another part is carried by PBCH Payload.
   Both SS and PBCH detection helps UE synchronize with the gNB (i.e., 5G base station) during initial network entry phase. 5G NR SS consists of PSS (Primary SS) and SSS (Secondary SS). A BPSK modulated m-sequence of length 127 is used for NR PSS whereas BPSK modulated Gold sequence of length 127 is used for NR SSS. Both PSS and SSS combination help to identify about 1008 physical cell identities. By detecting and decoding SS, UE can obtain physical cell identity, achieve downlink synchronization in time/frequency domain and acquire time instants of PBCH channel. Center frequency of PSS/SSS is aligned with center frequency of PBCH. PBCH carries very basic 5G NR system information for UEs. Any 5G NR compatible UE must have to decode information on PBCH in order to access the 5G cell.

Information carried by PBCH include following, downlink system bandwidth, timing information in radio frame, SS burst set periodicity, system frame number, other upper layer information.

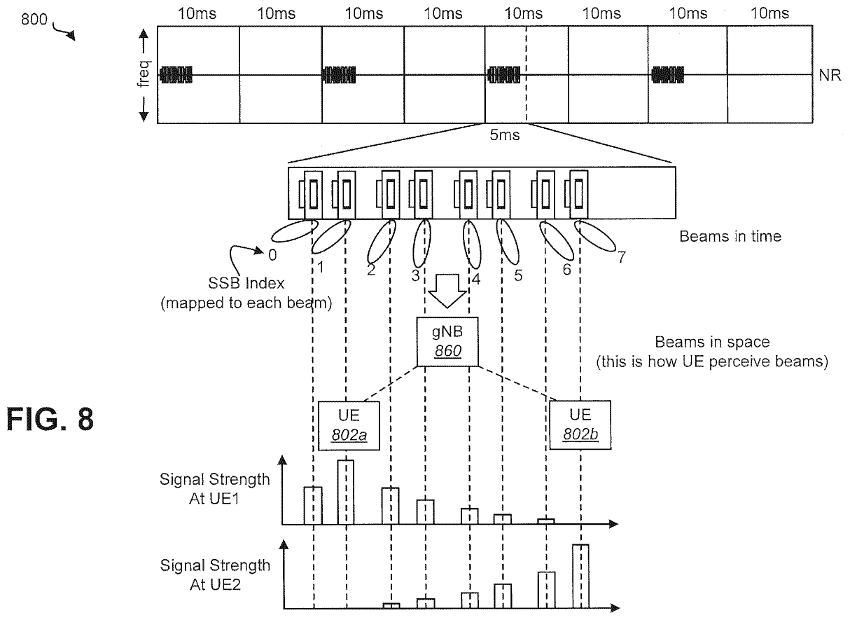

FIG. 8 is a diagram 800 illustrating one example of beam sweeping with an SSB burst. Beam sweeping is implemented by changing beam direction for each SSB transmission. For the mechanism by which UE measures and identifies the best beam for a UE, as shown in FIG. 8. The best beam to the UE (802a, 802b) is the beam with the best signal quality, e.g. with the best Received Signal Strength Indicator (RSSI) and/or Reference Signal Received Powe (RSRP) and/or Reference Signal Received Quality (RSRQ).
(1) Multiple SSBs are being transmitted with a certain interval.
(2) Each SSB can be identified by a unique number called SSB index.
(3) Each SSB is transmitted via a specific beam radiated in a certain direction.
(4) UE measures the signal strength of each SSB it detected for a certain period (a period of one SSB Set).
(5) From the measurement result, UE can identify the SSB index with the strongest signal strength. This SSB with the strongest signal strength is the best beam for the UE.
   In order to support beamforming, the synchronization signals with beam sweeping should be configured first. The scope of this invention involves the configuration and transmission of synchronization signals from NCR, and the side information required to support the configuration by the gNB 860 from the backhaul link.

Currently, there is no ability to do beamforming and spatial multiplexing on a amplify-and-forward repeater. On the other hand, an IAB node is treated as an gNB from the UE's perspective, and independent scheduling and beamforming are performed on the IAB to UE link.

A smart repeater (SR) or NCR, as 3GPP defines it, would not provide separate routing, but would be a single hop link. However, transparency of UE's links (802a, 802b) relayed to a gNB 860 needs to be maintained. To allow beamforming, some enhancements should be considered at NCR beyond the simple amplify-and-forward repeater.

The relevant use case for this and the benefit for all NCRs first and foremost is to be able to beamform or use MIMO, which is useful for exploiting the high capability for milli-meter wave (mmWave) spectrum to carry large amounts of data to a given unit area. Since milli-meter wave spectrum prefers not to propagate through walls, NCRs can be used to bring milli-meter wave spectrum from the inside to the outside and vice versa.

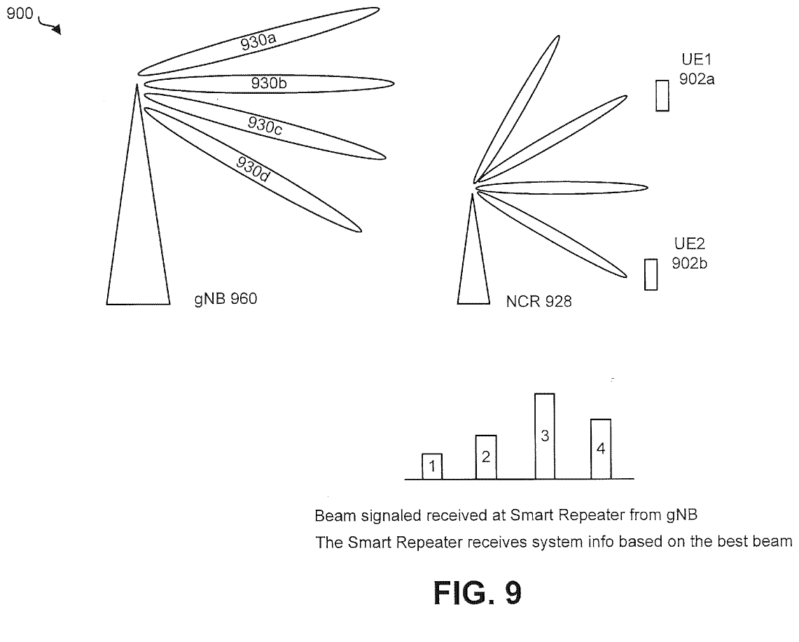

FIG. 9 is a diagram 900 illustrating one example SSB detection at an NCR and SSB regeneration. The network-controlled repeater 928 or the smart repeater should forward the serving cell configurations to UEs (902a, 902b) connected via the smart repeater.

For beam management, the gNB 960 transmits a sequence of SSB beams 930a-d with different directions in a SSB burst set, and the smart repeater (NCR 928) detects the best beam in the burst set to receive and decode the system information in PBCH.

The NCR 928 cannot simply forward the received SSBs (930a-d) to UEs (902a-902b) at least for the following reasons.

First, as illustrated, the NCR 928 received the SSB burst 930 from gNB 960, and detects the best beam with the best received signal quality, shown as beam 930c in FIG. 9. The other beams (930a, 930b, 930d) are weak because the beam directions are not aligned with the NCR 928. To forward SSBs (930a-d) and the system information, e.g., in the PBCH, the NCR 928 should not forward the SSBs (930a-d) received on other SSB indexes since the signal strength is already weak.

Even for the SSB with the best beam, since there is a SSB index associated with the each SSB and PBCH transmission, forwarding the SSB with the given index in SSB burst at different SSB index will cause wrong DMRS position and information RE mappings for the PBCH. With mis-matched indexes, the UE (902a or 902b) will not be able to decode the information from the PBCH.

Secondly, the beams between the gNB 960 and NCR 928 can be very different from the beam between the NCR 928 and the UE (902a or 902b). The beam from the gNB 960 to NCR 928 is the same to all UEs connected to the NCR 928, but the beams between the NCR 928 to different UEs can be different, as shown in FIG. 9 with different beams for UE1 902a and UE2 902b.

Thirdly, the NCR 928 may have different antenna panel configurations from the gNB 960. In general, the gNB 960 may have a much larger antenna array with a larger number of antennas than the NCR 928. Thus, the beams generated from the antenna array can also be different based on the antenna array configuration, e.g., the supported number of beams, and the analog beamforming functions.

Therefore, forwarding the SSBs (930a-d) from gNB 960 is not useful and not possible. The NCR 928 should regenerate the SSBs (930a-d) with its local beams with the system information obtained from the gNB 960 based on the received system information in the SSB and PBCH in the best beam from the gNB 960. Then the NCR 928 transmits the synchronization signals with PSS/SSS/PBCH with its local SSB bursts (930a-d) with local beam configurations.

Procedures of SSB generation and transmission for NCR Several methods can be considered for the procedures of SSB generation and transmission for NCR.

Method 1: NCR synchronization signals are configured by gNB based on reported NCR capabilities.

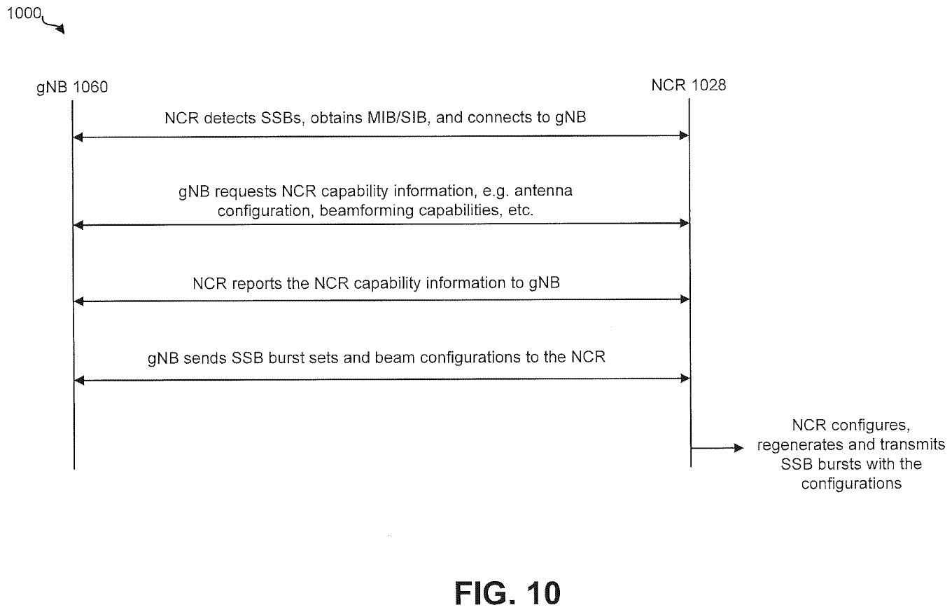

FIG. 10 is a sequence diagram 1000 illustrating one example of a procedure of SSB generation and transmission for NCR 1028. In one method, the NCR SSBs are configured by the gNB 1060 with side information by higher layer signaling, e.g., RRC configuration.

In order to configure the SSBs correctly, the gNB 1060 needs to obtain some NCR capability information, e.g., the NCR antenna configuration (or the number of SSBs the NCR 1028 can transmit within the SSB burst set), allowed beam configuration and beam refinement capabilities, etc. Then the gNB 1060 configures the SSBs, beam refinement procedures based on the NCR 1028 capabilities via higher layer signaling. This method may include the following steps:

Step 1: NCR 1028 detects SSBs from gNB 1060, and obtains MIB and SIB from the gNB 1060, and connects to the gNB 1060 through RACH procedure.

Step 2: gNB 1060 requests the NCR 1028 to report its capabilities, which includes but not limited to the antenna array configuration, maximum number of beams or the number of SSBs the NCR 1028 can transmit within the SSB burst set, etc. Step 2 is optional in case of NCR 1028 can report its capability without a request.

Step 3: NCR 1028 reports its capability to gNB 1060. Additionally, or alternatively, the NCR 1028 may report its capability to gNB 1060 even without a request from gNB 1060 in Step 2.

Step 4: gNB 1060 provides the SSBs and beam configurations for the NCR 1028 by higher layer signaling, i.e., RRC signaling, to the NCR 1028. The beam configurations may indicate specific transmit beams for each SSB in a SSB burst. The beam configuration may indicate a beam width and a beam sweeping range, etc.

Step 5: NCR 1028 configures and transmits the SSBs with beam sweeping based on the SSBs and beam configuration from gNB 1060.

For the synchronization signals transmitted by the NCR 1028, the NCR should regenerate and transmit the SSBs with different beams in different SSB instances in a SSB burst. The SSB and PBCH information can be the same as detected in the SSBs and PBCHs transmitted by the gNB 1060.

Additionally, or alternatively, the SSBs and PBCHs can include extra NCR specific parameters besides the information detected from the gNB 1060, or with information provided by gNB 1060 via higher layer signaling. For the SSB burst and beam configuration, the NCR 1028 may obtain configurations from gNB 1060 to decide the number of SSBs in a burst and the beams associated with the SSB transmissions. In one case, the SSBs and PBCHs for NCR 1028 can apply the same parameter values as detected in SSBs and PBCHs from the gNB 1060. In another case, the SSBs and PBCHs for NCR 1028 can include different parameter values than those included in SSBs and PBCHs from the gNB 1060. For example, the pdcchConfig-SIB1 may be changed with differentiate CORESET0 resources for NCR 1028 and gNB 1060.

Once the SSBs are configured for the NCR 1028, the NCR 1028 can then generate the SSBs and PBCHs with the configured MIB/SIB and transmit the SSB bursts with the allocated beams based on the SSB burst set configuration. Also, the gNB 1060 can reconfigure the SSBs for the NCR 1028 with higher layer signaling if necessary. For example, the gNB 1060 may configure a new beam width, and/or the number of SSBs and beams in a SSB burst to change the beam sweeping range. The gNB 1060 may change the SSB burst set configuration with a different periodicity and on/off pattern, etc.

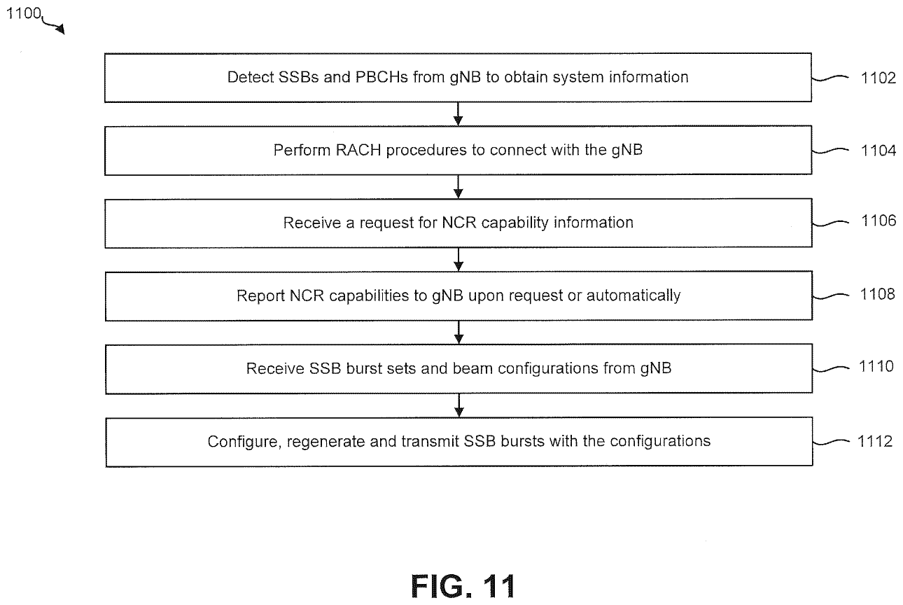

FIG. 11 is a flow diagram illustrating one example of a method 1100 for the NCR behavior associated with the sequence diagram of FIG. 10. The flow diagram illustrates NCR behavior for synchronization signal detection, regeneration, and transmission.

With Method 1, the NCR synchronization signal configuration is controlled by the gNB. The NCR just follows the configuration from the gNB. The gNB will ensure the configuration of the NCR will not cause collision with the synchronization signals from itself or other NCRs if present.

The NCR may detect 1102 SSBs and PBCHs from the gNB to obtain system information. The NCR may perform 1104 RACH procedures to connect with the gNB. The NCR may receive 1106 a request for NCR capability information. The NCR may report 1108 NCR capabilities to gNB upon request or automatically. The NCR may receive 1110 SSB burst sets and beam configurations from the gNB. The NCR may also configure 1112, regenerate, and transmit the SSB bursts with the configurations.

Method 2: NCR determines the synchronization signals locally

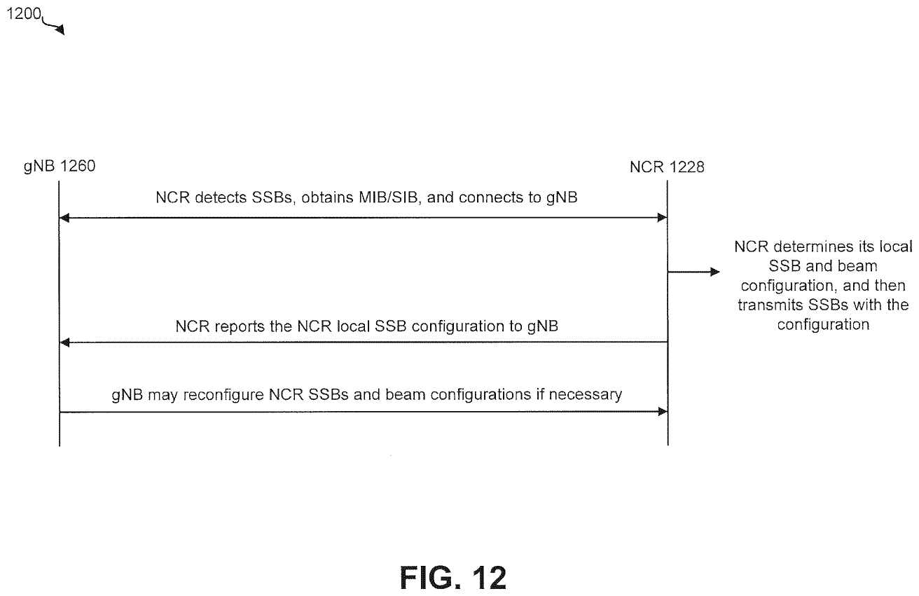

FIG. 12 is a sequence diagram 1200 illustrating another example of a procedure of SSB generation and transmission for NCR 1228. In another method, the NCR SSBs and beam setting can be performed locally by NCR 1228 itself, as shown in FIG. 12. With this method, the signaling overhead with gNB 1260 is reduced, and the NCR 1228 may have more flexibility to control the local operation.

Thus, the NCR 1228 may decide the number of SSBs in a burst and the beams associated with the SSB transmissions locally and report the configurations to the gNB 1260 automatically or upon request. And the gNB 1260 can reconfigure the SSBs for the NCR 1228 with higher layer signaling if necessary. For example, if the NCR synchronization signals have conflict with some other NCRs or the gNB 1260 itself, or misalignment with some slot configurations etc. This method may include the following steps:

Step 1: NCR 1228 detects SSBs from the gNB 1260, and obtains MIB and SIB from the gNB 1260, and connects to the gNB 1260 through RACH procedure.

Step 2: NCR 1228 determines the local beams and SSB configuration based on its own capabilities, which includes but not limited to the antenna array configuration, maximum number of beams or the number of SSBs the NCR 1228 can transmit within the SSB burst set, etc. The NCR 1228 then generates and transmits SSBs based on the determined local SSBs and beam configuration.

Step 3: NCR 1228 reports the local SSB configuration to the gNB 1260. The NCR 1228 may automatically or upon request report its capabilities such as antenna configuration, beamforming capabilities, etc.

Step 4: gNB 1260 may reconfigure the SSBs for the NCR 1228 with higher layer signaling if necessary.

In both methods, the detailed parameters, considerations and signaling for the configuration and reconfiguration will be discussed in a separate disclosure.

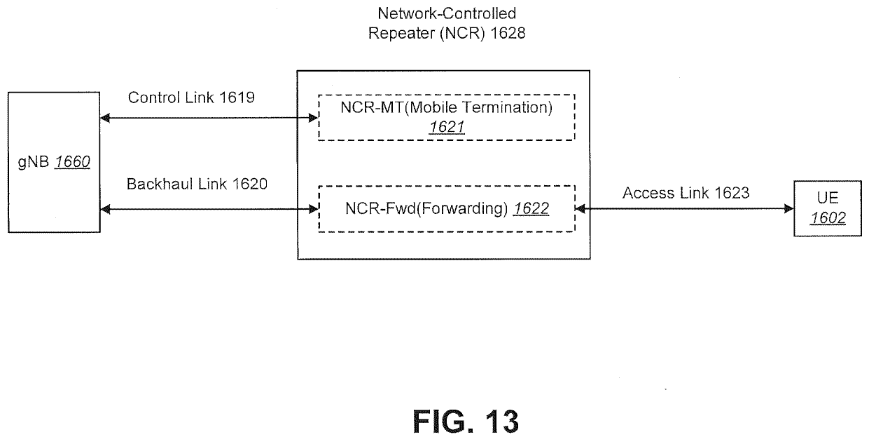

FIG. 13 is an example of a block diagram of an NCR 1628 framework. The NCR-MT 1621 (mobile termination) is defined as a function entity to communicate with a gNB 1660 via Control link 1619 (C-link) to enable the information exchanges (e.g. side control information). The C-link 1619 is based on NR UE interface. The side control information is at least for the control of NCR-Fwd 1622 (forwarding).

The NCR-Fwd 1622 is defined as a function entity to perform the amplify-and-forwarding of UL/DL RF signal between gNB 1660 and UE 1602 via backhaul link 1620 and access link 1623. The behavior of the NCR-Fwd 1622 will be controlled according to the received side control information from gNB 1660. The NCR-Fwd 1622 includes the backhaul link 1620 and the access link 1623.

The control link 1619 and the backhaul link 1620 at NCR 1628 can be performed simultaneously or in time division multiplexing (TDM).

The NCR 1628 can obtain the synchronization signals, e.g. SSBs and PBCH, MIB, and SIB, etc. on the NCR-MT 1621 and/or NCR-Fwd 1622. Furthermore, the NCR 1628 can receive the side information on NCR local configuration on control link 1619 with NCR-MT 1621.

This disclosure presents detailed methods on transmitting synchronization signals on the access link 1623.

As already discussed above, the NCR 1628 cannot simply amplify-and-forward the SSBs from the gNB 1660, and the NCR 1628 should regenerate the SSBs with its own configuration and transmitted with local beams.

### Synchronization Signal Configuration

The SSB burst set configuration from the gNB 1660 is indicated via various RRC parameters, including MIB and SIB1.

MIB

| -- | ASN1START | |
|---|---|---|
| -- | TAG-MIB-START | |
| MIB ::= | | SEQUENCE { |
| | systemFrameNumber | BIT STRING (SIZE (6)), |
| | subCarrierSpacingCommon | ENUMERATED {scs15or60, scs30or120}, |
| | ssb-SubcarrierOffset | INTEGER (0..15), |
| | dmrs-TypeA-Position | ENUMERATED {pos2, pos3}, |
| | pdcch-ConfigSIB1 | PDCCH-ConfigSIB1, |
| | cellBarred | ENUMERATED {barred, notBarred}, |
| | intraFreqReselection | ENUMERATED {allowed, notAllowed}, |
| | spare | BIT STRING (SIZE (1)) |

}

| | |
|---|---|
| -- | TAG-MIB-STOP |
| -- | ASN1STOP |

The MIB includes the system information transmitted on BCH, which includes the minimum information requires for cell identification. The parameters subCarrierSpacingCommon and ssb-SubcarrierOffset are related to SSB configuration.

Under SIB1, the following IEs are used for SSB configuration.

### ServingCellConfigCommon

The IE ServingCellConfigCommon is used to configure cell specific parameters of a UE's serving cell. The IE contains parameters which a UE would typically acquire from SSB, MIB or SIBs when accessing the cell from IDLB. With this IB, the network provides this information in dedicated signalling when configuring a UB with a SCells or with an additional cell group (SCG). It also provides it for SpColls (MCG and SCG) upon reconfiguration with sync.

ServingCellConfigCommon information element

| -- | ASN1START | |
|---|---|---|
| -- | TAG-SERVINGCELLCONFIGCOMMON-START | |
| ServingCellConfigCommon ::= | | SEQUENCE { |
| | physCellId | PhysCellId |

OPTIONAL, -- Cond HOAndServCellAdd,

| | |
|---|---|
| downlinkConfigCommon | DownlinkConfigCommon |

OPTIONAL, -- Cond HOAndServCellAdd

| | |
|---|---|
| uplinkConfigCommon | UplinkConfigCommon |

OPTIONAL, -- Need M

| | |
|---|---|
| supplementaryUplinkConfig | UplinkConfigCommon |

OPTIONAL, -- Need S

| | |
|---|---|
| n-TimingAdvanceOffset | ENUMERATED { n0, n25600, n39936 } |

OPTIONAL, -- Need S

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

}

OPTIONAL, -- Cond AbsFreqSSB

| | |
|---|---|
| ssb-periodicityServingCell | ENUMERATED { ms5, ms10, ms20, ms40, ms80, ms160, spare2, |

spare1 } OPTIONAL, -- Need S

| | |
|---|---|
| dmrs-TypeA-Position | ENUMERATED {pos2, pos3}, |
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE (1..maxNrofRateMatchPatterns)) OF |

RateMatchPattern OPTIONAL, -- Need N

| | |
|---|---|
| rateMatchPatternToReleaseList | SEQUENCE (SIZE (1..maxNrofRateMatchPatterns)) OF |

RateMatchPatternId OPTIONAL, -- Need N

| | |
|---|---|
| ssbSubcarrierSpacing | SubcarrierSpacing |

OPTIONAL, -- Cond HOAndServCellWithSSB

| | |
|---|---|
| tdd-UL-DL-ConfigurationCommon | TDD-UL-DL-ConfigCommon |

OPTIONAL, -- Cond TDD

| ss-PBCH-BlockPower | INTEGER (−60..50), |
|---|---|
| ..., | |
| [[ | |
| channelAccessMode-r16 | CHOICE { |
| dynamic | NULL, |
| semiStatic | SemiStaticChannelAccessConfig-r16 |

}

OPTIONAL, -- Cond SharedSpectrum

| | |
|---|---|
| discoveryBurstWindowLength-r16 | ENUMERATED {ms0dot5, ms1, ms2, ms3, ms4, ms5} |

OPTIONAL, -- Need R

| | |
|---|---|
| ssb-PositionQCL-r16 | SSB-PositionQCL-Relation-r16 |

OPTIONAL, -- Cond SharedSpectrum

| | |
|---|---|
| highSpeedConfig-r16 | HighSpeedConfig-r16 |

OPTIONAL -- Need R

]]

}

| | |
|---|---|
| -- | TAG-SERVINGCELLCONFIGCOMMON-STOP |
| -- | ASN1STOP |

ServingCellConfigCommon field descriptions

channelAccessMode
If present, this field indicates which channel access procedures to apply for operation with shared spectrum
channel access as defined in TS 37.213 [48]. If the field is configured as “semiStatic”, the UE shall apply the
channel access procedures for semi-static channel occupancy as described in subclause 4.3 in TS 37.213.
If the field is configured as “dynamic”, the UE shall apply the channel access procedures in TS 37.213, with
the exception of subclause 4.3 of TS 37.213.
dmrs-TypeA-Position
Position of (first) DM-RS for downlink (see TS 38.211 [16], clause 7.4.1.1.1) and uplink (TS 38.211 [16],
clause 6.4.1.1.3).
downlinkConfigCommon
The common downlink configuration of the serving cell, including the frequency information configuration
and the initial downlink BWP common configuration. The parameters provided herein should match the
parameters configured by MIB and SIB1 (if provided) of the serving cell, with the exception of
controlResourceSetZero and searchSpaceZero which can be configured in ServingCellConfigCommon
even if MIB indicates that they are absent.
discoveryBurstWindowLength
Indicates the window length of the discovery burst in ms (see TS 37.213 [48]).
longBitmap
Bitmap when maximum number of SS/PBCH blocks per half frame equals to 64 as defined in TS 38.213
[13], clause 4.1.
lte-CRS-ToMatchAround
Parameters to determine an LTE CRS pattern that the UE shall rate match around.
mediumBitmap
Bitmap when maximum number of SS/PBCH blocks per half frame equals to 8 as defined in TS 38.213 [13],
clause 4.1.
n-TimingAdvanceOffset
The N_TA-Offset to be applied for all uplink transmissions on this serving cell. If the field is absent, the UE
applies the value defined for the duplex mode and frequency range of this serving cell. See TS 38.133 [14],
table 7.1.2-2.
rateMatchPatternToAddModList
Resources patterns which the UE should rate match PDSCH around. The UE rate matches around the
union of all resources indicated in the rate match patterns. Rate match patterns defined here on cell level
apply only to PDSCH of the same numerology (see TS 38.214 [19], clause 5.1.4,1).
shortBitmap
Bitmap when maximum number of SS/PBCH blocks per half frame equals to 4 as defined in TS 38.213 [13],
clause 4.1.
ss-PBCH-BlockPower
Average EPRE of the resources elements that carry secondary synchronization signals in dBm that the NW
used for SSB transmission, see TS 38.213 [13], clause 7.
ssb-periodicityServingCell
The SSB periodicity in ms for the rate matching purpose. If the field is absent, the UE applies the value ms5.
(see TS 38.213 [13], clause 4.1)
ssb-PositionQCL
Indicates the QCL relation between SSB positions for this serving cell as specified in TS 38.213 [13], clause
4.1.
ssb-PositionsInBurst
For operation in licensed spectrum, indicates the time domain positions of the transmitted SS-blocks in a
half frame with SS/PBCH blocks as defined in TS 38.213 [13], clause 4.1. The first/leftmost bit corresponds
to SS/PBCH block index 0, the second bit corresponds to SS/PBCH block index 1, and so on. Value 0 in the
bitmap indicates that the corresponding SS/PBCH block is not transmitted while value 1 indicates that the
corresponding SS/PBCH block is transmitted. The network configures the same pattern in this field as in the
corresponding field in ServingCellConfigCommonSIB.
For operation with shared spectrum channel access, only mediumBitmap is used and the UE assumes that
one or more SS/PBCH blocks indicated by ssb-PositionsInBurst may be transmitted within the discovery
burst transmission window and have candidate SS/PBCH blocks indexes corresponding to SS/PBCH block
indexes provided by ssb-PositionsInBurst (see TS 38.213 [13], clause 4.1). If the k-th bit of
ssb-PositionsInBurst is set to 1, the UE assumes that one or more SS/PBCH blocks within the discovery
burst transmission window with candidate SS/PBCH block indexes corresponding to SS/PBCH block index
equal to k − 1 may be transmitted; if the kt-th bit is set to 0, the UE assumes that the corresponding
SS/PBCH block(s) are not transmitted. The k-th bit is set to 0, where k > ssb-PositionQCL and the number
of actually transmitted SS/PBCH blocks is not larger than the number of 1's in the bitmap. The network
configures the same pattern in this field as in the corresponding field in ServingCellConfigCommonSIB.
ssbSubcarrierSpacing
Subcarrier spacing of SSB. Only the values 15 kHz or 30 kHz (FR1), and 120 kHz or 240 kHz (FR2) are
applicable.
supplementaryUplinkConfig
The network configures this field only if uplinkConfigCommon is configured. If this field is absent, the UE
shall release the supplementaryUplinkConfig and the supplementaryUplink configured in
ServingCellConfig of this serving cell, if configured.
tdd-UL-DL-ConfigurationCommon
A cell-specific TDD UL/DL configuration, see TS 38.213 [13], clause 11.1.

### ServingCellConfigCommonSIB

The IE ServingCellConfigCommonSIB is used to configure cell specific parameters of a UE's serving cell in SIB1.

ServingCellConfigCommonSIB information element

| -- | ASN1START | |
|---|---|---|
| -- | TAG-SERVINGCELLCONFIGCOMMONSIB-START | |
| ServingCellConfigCommonSIB ::= | | SEQUENCE { |
| | downlinkConfigCommon | DownlinkConfigCommonSIB, |
| | uplinkConfigCommon | UplinkConfigCommonSIB |

OPTIONAL, -- Need R

| | |
|---|---|
| supplementaryUplink | UplinkConfigCommonSIB |

OPTIONAL, -- Need R

| | |
|---|---|
| n-TimingAdvanceOffset | ENUMERATED { n0, n25600, n39936 } |

OPTIONAL, -- Need S

| | |
|---|---|
| ssb-PositionsInBurst | SEQUENCE { |
| inOneGroup | BIT STRING (SIZE (8)), |
| groupPresence | BIT STRING (SIZE (8)) OPTIONAL |

-- Cond FR2-Only

| }, | |
|---|---|
| ssb-PeriodicityServingCell | ENUMERATED {ms5, ms10, ms20, ms40, ms80, ms160}, |
| tdd-UL-DL-ConfigurationCommon | TDD-UL-DL-ConfigCommon |

OPTIONAL, -- Cond TDD

| ss-PBCH-BlockPower | INTEGER (−60..50), |
|---|---|
| ..., | |
| [[ | |
| channelAccessMode-r16 | CHOICE { |
| dynamic | NULL, |
| semiStatic | SemiStaticChannelAccessConfig-r16 |

}

OPTIONAL, -- Cond SharedSpectrum

| | |
|---|---|
| discoveryBurstWindowLength-r16 | ENUMERATED {ms0dot5, ms1, ms2, ms3, ms4, ms5} |

OPTIONAL, -- Need R

| | |
|---|---|
| highSpeedConfig-r16 | HighSpeedConfig-r16 |

OPTIONAL -- Need R

]]

}

| | |
|---|---|
| -- | TAG-SERVINGCELLCONFIGCOMMONSIB-STOP |
| -- | ASN1STOP |

ServingCellConfigCommonSIB field descriptions

channelAccessMode
If present, this field indicates which channel access procedures to apply for operation with shared spectrum
channel access as defined in TS 37.213 [48]. If the field is configured as “semiStatic”, the UE shall apply the
channel access procedures for semi-static channel occupancy as described in subclause 4.3 in TS 37.213. If
the field is configured as “dynamic”t, the UE shall apply the channel access procedures in TS 37.213, with
the exception of subclause 4.3 of TS 37.213.
discoveryBurstWindowLength
Indicates the window length of the discovery burst in ms (see TS 37.213 [48]).
groupPresence
This field is present when maximum number of SS/PBCH blocks per half frame equals to 64 as defined in
TS 38.213 [13], clause 4.1. The first/leftmost bit corresponds to the SS/PBCH index 0-7, the second bit
corresponds to SS/PBCH block 8-15, and so on. Value 0 in the bitmap indicates that the SSBs according to
inOneGroup are absent. Value 1 indicates that the SS/PBCH blocks are transmitted in accordance with
inOneGroup.
inOneGroup
When maximum number of SS/PBCH blocks per half frame equals to 4 as defined in TS 38.213 [13], clause
4.1, only the 4 leftmost bits are valid; the UE ignores the 4 rightmost bits. When maximum number of
-SS/PBCH blocks per half frame equals to 8 as defined in TS 38.213 [13], clause 4.1, all 8 bits are valid.
The first/leftmost bit corresponds to SS/PBCH block index 0, the second bit corresponds to SS/PBCH block
index 1, and so on. When maximum number of SS/PBCH blocks per half frame equals to 64 as defined in
TS 38.213 [13], clause 4.1, all 8 bit are valid; The first/leftmost bit corresponds to the first SS/PBCH block
index in the group (i.e., to SSB index 0, 8, and so on); the second bit corresponds to the second SS/PBCH
block index in the group (i.e., to SSB index 1, 9, and so on), and so on. Value 0 in the bitmap indicates that
the corresponding SS/PBCH block is not transmitted while value 1 indicates that the corresponding
SS/PBCH block is transmitted.
n-TimingAdvanceOffset
The N_TA-Offset to be applied for random access on this serving cell. If the field is absent, the UE applies
the value defined for the duplex mode and frequency range of this serving cell. See TS 38.133 [14], table
7.1.2-2.
ssb-PositionsinBurst
Time domain positions of the transmitted SS-blocks in an SS-burst as defined in TS 38.213 [13], clause 4.1.
For operation with shared spectrum channel access, only inOneGroup is used and the UE interprets this field
same as mediumBitmap in ServingCellConfigCommon. The UE assumes that a bit at position
$k > {N}_{SSB}^{QCL}$
$is 0 , where {N}_{SSB}^{QCL}$
is obtained from MIB as specified in TS 38.213 [13], clause 4.1.
ss-PBCH-BlockPower
Average EPRE of the resources elements that carry secondary synchronization signals in dBm that the NW
used for SSB transmission, see TS 38.213 [13], clause 7.

In general, there are two potential methods for synchronization signal transmission at NCR 1628.

Side information for synchronization signaling configuration and transmissions of Network Controlled Repeaters (NCR).

Method 1: NCR transmits synchronization signals following side information with separate NCR SSB configuration from gNB

In this method, the NCR 1628 does not forward any SSBs from gNB 1660 from the backhaul link 1620 to the access link 1623. Instead, the NCR 1628 transmits synchronization signals with a new synchronization signal structure provided by the gNB 1660 with side information on the control link 1619.

The SSB burst from the NCR 1628 may be configured separately from the SSB burst from the gNB 1660, and the NCR 1628 generates and transmits PBCH and PDSCH for SIB1 information based on local SSBs and beam configurations.

There are some aspects to be considered for the synchronization signal configuration for NCR 1628.

The synchronization signal structure for SSBs transmitted by the NCR 1628, may be configured by the gNB 1660 with a side information entity. The side information may define the synchronization signal structure at the NCR 1628, including SSB burst periodicity, the number of SSBs in a burst, and the SSB burst bitmaps etc. The side information may be carried in a MAC CE, or by a higher layer signaling from the gNB 1660.

The synchronization signal structure for the NCR 1628 can be the same or different from the synchronization structure transmitted from gNB 1660. The NCR 1628 normally has a smaller number of antennas and less capability than the gNB 1660. Thus, the number of SSBs in a SSB burst transmitted by the NCR 1628, should be the same or smaller than the number of SSBs in a SSB burst from the gNB 1660. If periodicity of SSB burst sets transmitted by the NCR 1628 can be the same as or longer than the periodicity of SSB burst sets from the gNB 1660.

The SSB configuration at NCR 1628 should not conflict with the SSBs from the gNB 1660. The NCR SSB bursts should occupy a 5 ms duration half frame that is nonoverlapping with the 5 ms half frame for SSB bursts from the gNB 1660.

Alternatively, the NCR 1628 and gNB 1660 may use the same 5 ms half slot, but the transmission is handled by different bitmaps so that the gNB 1660 and NCR 1628 will not transmit the SSBs in the same SSB burst duration.

In this method, the NCR 1628 will not forward any SSBs received on the backhaul link 1620 on the access link 1623. On the other hand, the UE 1602 only receives the SSB configuration from NCR 1628, and does not know the SSB configuration from the gNB 1660. Thus, the UE 1602 performs synchronization based on NCR SSB configurations only.

Additionally, or alternatively, the NCR SSB configuration can be signaled to UE 1602 by gNB 1660 via PDSCH, e.g. in the ServingCellConfigCommon IE. Thus, the UE 1602 will have the same understanding as the NCR 1628.

Furthermore, if the gNB SSB configuration is different from the NCR SSB configuration, the NCR 1628 may need to regenerate the MIB and/or SIB in the corresponding SSBs and PDSCHs by replacing the gNB SSB configuration with the local NCR SSB configuration.

The MIB information transmitted on the PBCH regenerated by the NCR 1628 may contain exactly the same as the MIB information received on PBCH from gNB 1660, especially if the NCR 1628 is operating on the same carrier as the gNB 1660.

Additionally, or alternatively, the gNB 1660 may indicate a different MIB information via a side information. The side information can be carried in a dedicated layer 1 signal (e.g. a dedicated PBCH), or by a MAC CE, or by higher layer signaling (e.g. with a new information element ncr-MIB).

| ncr-MIB ::= | | SEQUENCE { |
|---|---|---|
| | systemFrameNumber | BIT STRING (SIZE (6)), |
| | subCarrierSpacingCommon | ENUMERATED {scs15or60, scs30or120}, |
| | ssb-SubcarrierOffset | INTEGER (0..15), |
| | dmrs-TypeA-Position | ENUMERATED {pos2, pos3}, |
| | pdcch-ConfigSIB1 | PDCCH-ConfigSIB1, |
| | cellBarred | ENUMERATED {barred, notBarred}, |
| | intraFreqReselection | ENUMERATED {allowed, notAllowed}, |
| | spare | BIT STRING (SIZE (1)) |

}

| | |
|---|---|
| -- | TAG-MIB-STOP |
| -- | ASN1STOP |

If a ncr-MIB is received at the NCR 1628, the NCR should replace the MIB detected from gNB 1660 with the new MIB information provided in ncr-MIB. The NCR 1628 then generates and transmits the PBCH with the new MIB.

Similarly, the side information may include different NCR SSB configurations that should be included in the local PBCH and/or SIB1 information. The side information may include new SSB configurations in new IEs, e.g. ncr_ServingCellConfigCommon and ncr_ServingCellConfigCommonSIB, etc. Especially, if different SSB configurations are applied at NCR 1628, the following elements related to SSB should be included, e.g.

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

}
OPTIONAL, -- Cond AbsFreqSSB

| | |
|---|---|
| ssb-periodicityServingCell | ENUMERATED { ms5, ms10, ms20, ms40, ms80, ms160, spare2, |

spare1 } OPTIONAL, -- Need S

The gNB 1660 should configure the synchronization signal structure based on the NCR capabilities, including the periodicity, number of NCR SSBs in a burst, the bitmap etc.

Synchronization Signal Forwarding Timing and SSB Transmission Positions for Network Controlled Repeaters (NCR)

Method 2: NCR follows the synchronization signal structure of the gNB, and replace the transmissions by regenerated SSBs with local beams.

With Method 1, the NCR 1628 may need to regenerate SSBs and/or MIB and/or SIB with new synchronization signal configuration. Thus, it could be more complicated. Furthermore, extra processing is required to separately handle the gNB SSBs and NCR SSB handling.

In another method, the NCR 1628 may decode the SSBs, PBCH, MIB and SIB etc, and forward the synchronization signals without changing the content of the synchronization signal and the synchronization signal structure. However, since the beams from NCR 1628 to UE 1602 is totally different from the beams between the gNB 1660 and NCR 1628, the SSBs still needs to be regenerated with the local SSB indexes and local beams.

Even by reusing the gNB SSB configuration, the NCR 1628 has to determine several aspects for the local NCR SSB transmission, including, the SSB forwarding timing, which SSB positions are used for the NCR SSB transmission, and how to map the NCR beam with the gNB SSB indexes, etc.

### SSB Forwarding Timing

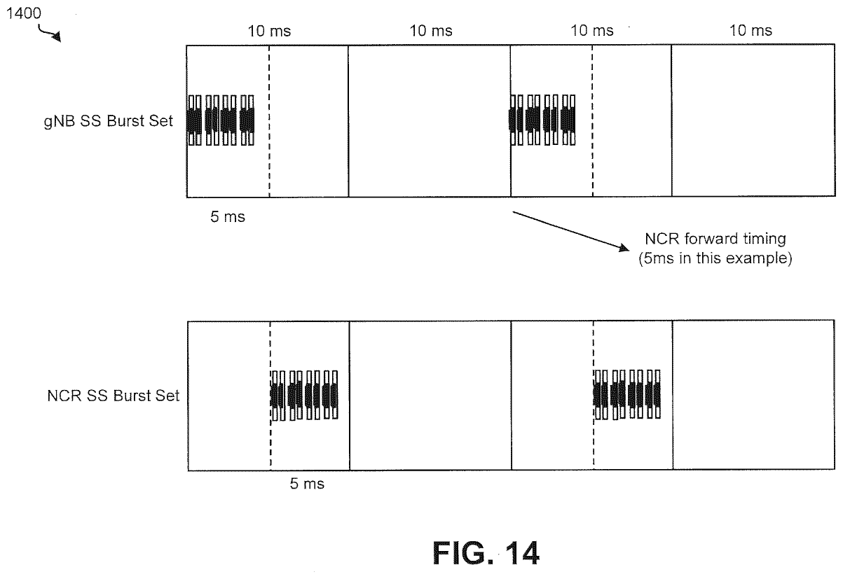

FIG. 14 is one example of a timing diagram 1400 illustrating synchronization signal forwarding timing at the NCR. With Method 2, the synchronization signal forwarding timing should be defined first. Since SSB bursts occupy a 5 ms period, the forwarding delay should be at least 5 ms so the NCR can listen to all SSBs and beams from the gNB before forwarding to UE. Furthermore, the forwarding SSBs should not overlap with the SSBs from gNB.

Thus, the forwarding delay of SSBs at NCR can be fixed as 5 ms, as shown in FIG. 14. Alternatively, the forwarding delay of SSBs at NCR can be configured with a number of slots that is greater or equal to 5 ms. The forward delay can be multiples of 5 ms as preferred value. The forward timing can be indicated by a side information from gNB, e.g. with an offset value in a number of slots.

Alternatively, the SSBs from NCR can occupy the remaining 5 ms of a radio frame for the gNB SSB burst. If the gNB SSBs occupies the first 5 ms of a radio frame, the SSBs from NCR use the second 5 ms in the radio frame. If the gNB SSBs occupies the second 5 ms of a radio frame, the SSBs from NCR use the first 5 ms in the radio frame.

In general, the NCR SSB transmissions follow the same SSB burst set configuration with a different starting slot. The SSBs from NCR need to be generated with local beams with the same system information as gNB SSBs. The SSB configuration at NCR should not conflict with the SSBs from the gNB. The NCR SSB bursts should occupy a 5 ms duration half frame that is non-overlapping with the 5 ms half frame for SSB bursts from the gNB. The NCR SSB transmission timing may be determined by an NCR SSB configuration with a different offset value.

The synchronization signal forwarding timing can be separately determined from the data forwarding timing from backhaul link to access link. For data forwarding in a slot with NCR SSBs, the gNB should ensure the corresponding REs for NCR SSB is not scheduled in the forwarded slot on the backhaul link. Or the corresponding REs will be punctured by the NCR SSB transmission.

### NCR SSB Mapping in the SSB Burst

Since the beams from NCR to UE is totally different from the beams between the gNB and NCR, the SSBs still needs to be regenerated and transmitted with local beams. The number of beams supported by an NCR may be much smaller than that of a gNB.

The number of beams supported by the NCR may be determined by NCR capability, e.g. from OAM or hard-coded. The number of beams supported by the NCR may be configured be the gNB.

If the number of beams supported by a NCR is smaller than that of a gNB, how to transmit the NCR SSBs in the burst should be further defined. The NCR should transmit local SSBs with local beams following the synchronization signal structure and the forward timing/delay given above.

Approach 1: the NCR SSBs are transmitted with one-to-one mapping based on the beam indexes.

In one approach, the NCR SSBs are transmitted with a one-to-one mapping between the SSB indexes and NCR beam indexes. Thus, the total number of SSBs transmitted in the SSB structure is the same as the number of beams configured at NCR. If the number of SSBs in the SSB configuration, i.e. the number of beams configured at gNB, is greater than the number of beams configured at NCR, only part of the SSB positions are used for NCR SSB transmission.

Approach 1-1: Map from the Beginning of the SSB Burst Set

In this approach, a SSB from NCR is regenerated with the received MIB/SIB content from gNB, and transmitted with local beams with the order of local beam indexes. Thus, the NCR SSB index is the same as the NCR beam index, i.e. NCR SSB with NCR beam index 0 is mapped on the first SSB with index 0 in the SSB burst, and NCR SSB with NCR beam index 1 is mapped on the second SSB with index 1 in the SSB burst, and so on, until all NCR beams are transmitted.

Assume there are N beams in a SSB burst configuration from gNB, and M local beams at NCR, where M<=N, the NCR will transmit local SSBs in the first M SSBs, and not transmit in the remaining N-M SSBs in the burst. The remaining N-M SSBs in the burst should be emptied out without transmission.

It is transparent from UE's perspective. The UE receives the SSB configuration, and detects and feedback the best beam, since the last N-M SSBs in the burst are not transmitted, the can only detects the best beam from the M beams transmitted by the NCR. There will be no ambiguity for the NCR beam index feedback. The beam index is the same as SSB index.

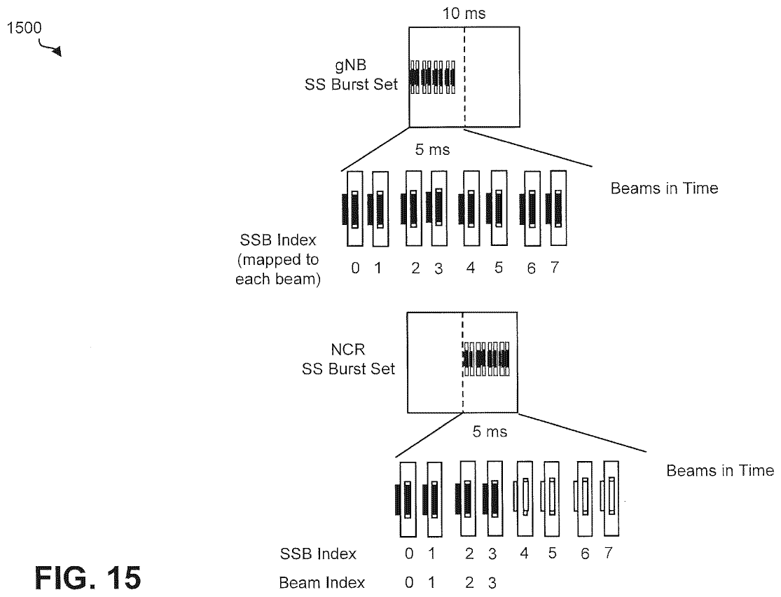

FIG. 15 is a diagram 1500 showing an example where gNB has 8 beams in the SS burst set, and the NCR only has 4 beams. The NCR beams are mapped to the first 4 SSB indexes, and the NCR does not transmit in the remaining SSB positions.

Approach 1-2: Map with a Separate Configured Pattern

In another approach, gNB can configure a separate pattern for SSB transmission to NCR, e.g. a information element with SSB positions in burst, e.g. ncr-ssb-PositionsInBurst. Alternatively, the gNB can signal an on/off mask over the existing ssb-PositionsInBurst. The configuration can be provided by side information on the control link, e.g. with a higher layer information element. The dedicated SSB positions in burst defines the SSBs positions to be transmitted by the NCR. The on/off mask with a bitmap, e.g. 1 indicates the SSB is transmitted, and 0 indicates the SSB is not transmitted. In both cases, the number of SSBs to be transmitted should be equal to the number of beams supported or configured for the NCR.

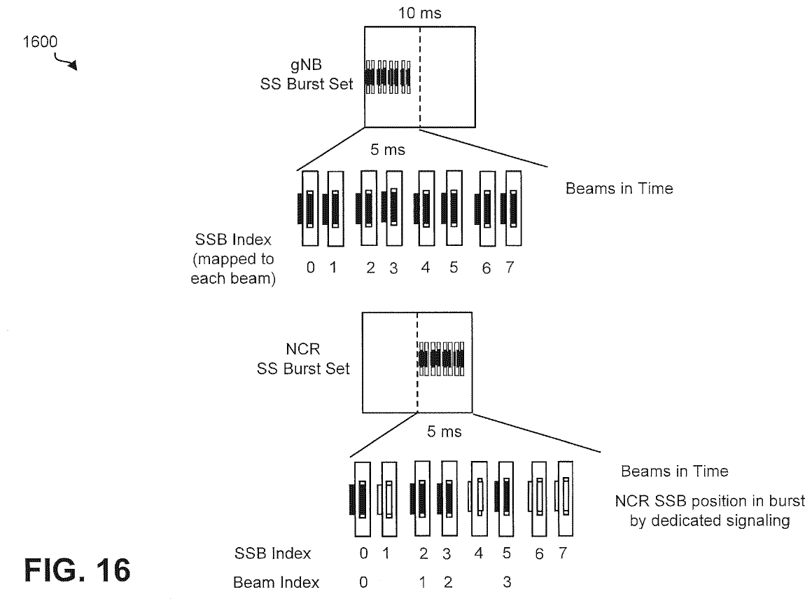

FIG. 16 is a diagram 1600 of an NCR SSB transmission by dedicated SSB positions in burst signaling. In the example shown in FIG. 16, the NCR SSB positions with the gNB SSB structure are determined by dedicated signaling, and the NCR will not transmit in other SSB positions.

It can be transparent from UE's perspective. The UE receives the SSB configuration and detects and reports the best beam with the corresponding beam index. The gNB receives the beam index then determines the actual NCR beam based on the dedicated ssbPositionsinBurst IE for the NCR. In this case, the UE reports the SSB index based on the SSB burst set configuration. The gNB and/or can then derive the actual NCR beam based on the NCR SSB positions configuration. The NCR beam index may not be the same as the SSB index reported by the UE. For example, in FIG. 11, the UE reports the best beam with SSB index 3, which is corresponding to NCR beam index 2.

Alternatively, or additionally, a new feature can be specified for UE to support additional dedicated ssb-PositionsInBurst or an on/off bitmap from gNB. If the UE supports the additional ssb-PositionsInBurst or on/off bitmap, it can detect the beam indexes based on the ssb positions in the burst.

Synchronization Signal Block (SSB) Transmissions with Beam Repetition for Network Controlled Repeaters (NCR)

Approach 2: The NCR SSBs are Transmitted with Repetitions

Currently, each SSB in a SSB burst is transmitted with a different beam. No beam repetition is allowed. This is the same as in Approach 1, where the remaining N-M SSB locations in a burst is wasted by no transmission.

Since the gNB SSB burst set structure is maintained by the NCR, the SSB resources will be wasted if SSBs are not transmitted. To enhance the synchronization and beam detection performance, new features can be introduced for NCR on the SSB transmission to support SSB repetition with the same beam in a SSB burst set. It is always beneficial to support SSB repetition at NCR when the number of NCR beams is smaller than the number of beams at the gNB. It can enhance the beam detection and selection from the UE.

At least, two types of SSB repetition can be considered.

Approach 2-1: Cyclic Beam Mapping with Repetition

In this approach, a SSB from NCR is regenerated with the received MIB/SIB content from gNB, and transmitted with local beams with the order of local beam indexes. Thus, NCR SSB with NCR beam index 0 is mapped on the first SSB with index 0 in the SSB burst, and NCR SSB with NCR beam index 1 is mapped on the second SSB with index 1 in the SSB burst, and so on, until all NCR beams are transmitted. Then the SSBs are transmitted again from beam index 0 again.

The beams in SSBs can be applied until all remaining SSB locations in the burst set is occupied, or until a number of repetitions k is reached. The number of repetitions k can be provided by gNB by side information. The side information may be indicated by layer 1 DCI, or in a MAC CE, or by higher layer RRC signaling.

Thus, if there are N beams in a SSB burst configuration from gNB, and M local beams at NCR, where M<=N, the NCR will transmit with beam index 0 in SSB indexes 0, M, . . . kM, where kM<=N. Therefore, multiple SSBs may be transmitted with the same beam.

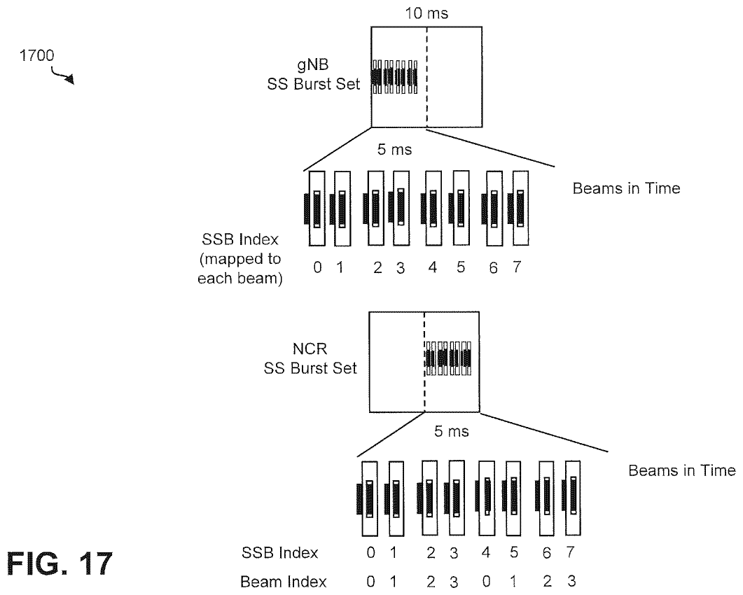

FIG. 17 is a diagram 1700 showing cyclic beam mapping at NCR. In the example shown in FIG. 17, the gNB has 8 beams in the SS burst set, and the NCR only has 4 beams. The NCR beams are mapped to the first 4 SSB indexes, and then repeat in the next 4 SSBs.

Approach 2-2: Continuous Mapping with Repetition

In this approach, the NCR repeats each beam in consecutive SSBs first, then switch to the next beam. The number of repetitions can be provided by gNB by side information. The side information may be indicated by layer 1 DCI, or in a MAC CE, or by higher layer RRC signaling.

Thus, if there are N beams in a SSB burst configuration from gNB, and M local beams at NCR, and the number of repetitions of each beam is k, where kM<=N, the NCR will transmit with beam index 0 in SSB indexes 0 to SSB index k−1, and beam index 1 in SSB indexes 1 and k, and so on. Again, multiple SSBs may be transmitted with the same beam.

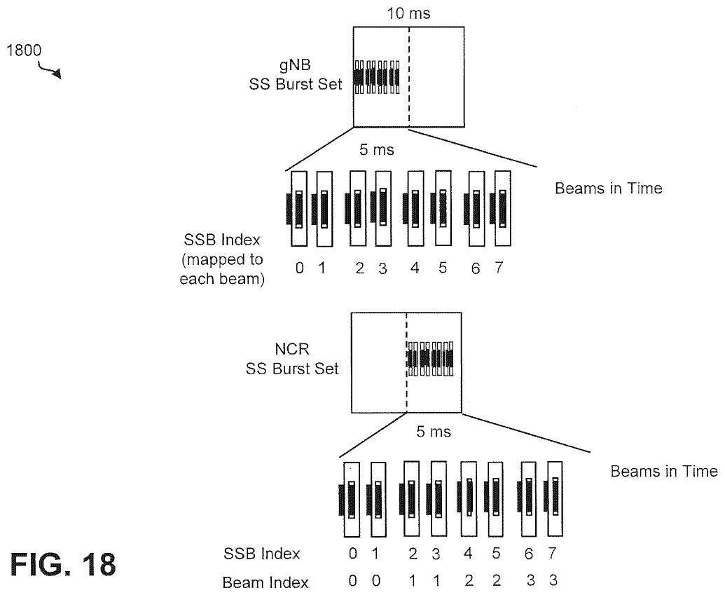

FIG. 18 is a diagram 1800 showing continuous repetition beam mapping at NCR. In the example shown in FIG. 18, the gNB has 8 beams in the SS burst set, and the NCR only has 4 beams, and the repetition factor is 2. Each NCR beam is mapped to 2 consecutive SSB indexes, and all 8 locations in the SS burst set is used.

To select approach 2-1 or approach 2-2, the type of repetition can be configured by gNB via a side information. The side information may be indicated by layer 1 DCI, or in a MAC CE, or by higher layer RRC signaling.

With approach 2, all SS burst locations may be used for SSB transmission, and multiple SSB transmission may use the same beam index from NCR. The NCR and gNB know the SSB index to beam index mapping, so it can correctly determine the NCR beam index from UE feedback.

UE Behavior with SSB Repetitions

In one approach, it may be transparent from UE's perspective. The UE receives the SSB configuration and detects and reports the best beam with the corresponding SSB index. The UE does not know that multiple SSBs are using the same beam, and will treat them as separate beams.

The gNB receives the SSB index reported from UE, then determines the actual NCR beam index based on the repetition method. The NCR beam index may not be the same as the SSB index reported by the UE since the same beam may be mapped in multiple SSBs.

For example, if the gNB configures 8 beams, and NCR has 4 beams, and if the UE reports SSB index 5 is the best beam,
if cyclic repetition is applied, the gNB then determines the best NCR beam is given by beam index 1 obtained by 5 minus 4, as shown in FIG. 12,
if continuous repetition with factor 2 is applied, the gNB then determines the best NCR beam is given by beam index 2 obtained by 5 minus 2*2 for beam indexes 0 and 1, as shown in FIG. 13.

In another approach, a new feature can be specified for UE to support NCR beam repetitions. If the number of NCR beams, the beam repetition method and parameters are indicated to the UE by the gNB or the NCR, the UE can perform beam selection more accurately by combining the SSBs with the same beam. With this approach, the UE can report the best NCR beam index even if the number of SSB in the burst set is different from the number of beams of the NCR.

Procedures of synchronization signal generation and transmission for Network Controlled Repeaters (NCR).

An NCR node can perform separate beam management for the link between the gNB 1260 and NCR 1228, and the link between the NCR 1228 and UE. For the local synchronization signal generation and transmission:
The NCR 1228 detects the SSBs and PBCHs from the gNB 1260 to obtain the MIB/SIB information to be broadcasted in its local SSBs and PBCHs, and/or the NCT receives dedicated MIB/SIB information to be broadcasted in its local SSBs and PBCHs by higher layer signaling from gNB 1260.
And the NCR 1228 determines the local NCR SSB burst set and beam configuration based on some higher layer signaling.
Then the NCR 1228 regenerates the SSBs and PBCHs with the detected or indicated information, and transmits the synchronization signals following the local NCR SSB burst set and beam configuration.

For the information in the synchronization signals transmitted by the NCR 1228, the NCR 1228 should decode and regenerate the SSBs with different beams in different SSB instances in a SSB burst based on the SSB burst set and beam configuration from the gNB 1260.
The SSB and PBCH information can be the same as detected in the SSBs and PBCHs transmitted by the gNB 1260.
Additionally, or alternatively, the SSBs and PBCHs can include extra NCR specific parameters besides the detected information from the gNB 1260. For example, the NCR 1228 may include some information provided by gNBs via higher layer signaling, e.g. with some different parameter values than those included in SSBs and PBCHs from the gNB 1260.

For the SSB burst and beam configuration,
In one method, the NCR 1228 may report its beamforming capability and/or antenna configuration to gNB 1260, and then obtain NCR synchronization signal configuration from the gNB 1260 to decide the number of SSBs in a burst and the beams associated with the SSB transmissions.
In another method, the NCR 1228 may decide the NCR synchronization signal configuration, and report the configuration to gNB automatically or upon request.
In both methods, the gNB 1260 may reconfigure the SSB burst and beam configuration for the NCR 1228 via higher layer signaling.

Side information for synchronization signaling configuration and transmissions of Network Controlled Repeaters (NCR)

The gNB separately configures synchronization signal structure and configuration for NCR with side information. The NCR synchronization signal configuration overrides the gNB synchronization signals configuration.
The side information may include the SS burst set configuration for NCR with periodicity, number of SSBs in the burst set, bit-map pattern, etc.
   The NCR SS burst set should occupy a different 5 ms period from the gNB SS burst set.
   The number of beams at NCR should be smaller or equal to the number of beams at gNB.
   The periodicity of NCR SS burst set may be longer or the same as gNB SS burst set.
The side information may be indicated by DCI, or MAC CE or RRC signaling with new information elements.

The NCR will not forward the SSBs received on the backhaul link and/or control link, and will empty out the resource elements occupied by the gNB SSBs if the slot is forwarded on the access link.

The NCR regenerates the SSBs, and/or SIB etc, with the provided information and transmit following the indicated SS burst set structure with local beams.

The NCR may overwrite the MIB and/or SIB in the synchronization signals with the new synchronization signal configuration.

Synchronization Signal Forwarding Timing and SSB Transmission Positions for Network Controlled Repeaters (NCR)

The NCR does not change any MIB and or SIB information, and follows the gNB SS Burst set configuration.

The NCR regenerates the SSBs, and/or SIB etc, with the received information and transmits using the gNB SS burst set structure with local beams with a forwarding delay.

### Synchronization Signal Forwarding Timing.

The synchronization signal forwarding timing or delay may be 5 ms or multiple of 5 ms or configured by gNB.
The NCR synchronization signals may occupy the other 5 ms in the radio frame where the gNB synchronization signal is transmitted.
The synchronization signal forwarding timing is separately determined from the data forwarding from backhaul link to access link

### NCR SSB Mapping in the SSB Burst

Approach 1: the NCR SSBs are transmitted with one-to-one mapping based on the beam indexes.
Approach 1-1: The NCR transmits SSBs with local beams with the order of local beam indexes until all NCR beams are transmitted. If there are more SSBs in the burst set, the NCR will empty out and not transmit any SSB.
Approach 1-2: map with a separate configured pattern with dedicated SSB positions in burst, e.g. ncr-ssb-PositionsInBurst or an on/off bitmap pattern. The dedicated SSB positions in burst or the on/off bitmap pattern defines the SSBs positions to be transmitted by the NCR. The number of SSBs to be transmitted should be equal to the number of beams supported or configured for the NCR.
   Synchronization Signal Block (SSB) Transmissions with Beam Repetition for Network Controlled Repeaters (NCR)
   Approach 2: The NCR SSBs are Transmitted with Repetitions

Multiple SSB transmissions with the same beam is supported if the number of NCR beams is smaller than the number of SSBs in the SS burst set of the gNB.
Approach 2-1: cyclic mapping with repetition: The NCR transmits SSBs with local beams with the order of local beam indexes until all NCR beams are transmitted. Then repeat.
Approach 2-2: continuous mapping with repetition: The NCR transmits SSBs with the same beams multiple times before switching to the next beam. The number of repetitions can be provided by gNB by side information

UE behavior with SSB repetitions (may not need to be claimed)

### Approach 1: Transparent to UE (No Change on UE Behavior).

The UE receives the SSB configuration and detects and reports the best beam with the corresponding beam index.
The gNB receives the beam index then determines the actual NCR beam based on the repetition method.

### Approach 2: New Feature

A new feature can be specified for UE to support NCR beam repetitions.
If the number of NCR beams, the beam repetition method and repetition parameter are indicated to the UE by gNB or by NCR, the UE can perform beam selection more accurately by combining the SSBs with the same beam.

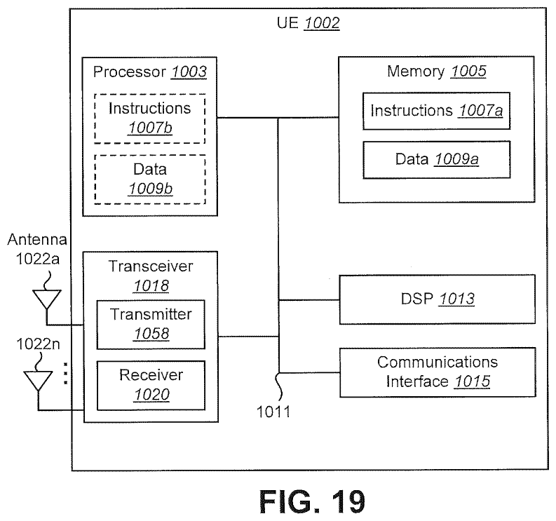

FIG. 19 illustrates various components that may be utilized in a UE 1002. The UE 1002 described in connection with FIG. 19 may be implemented in accordance with the UE 102 described in connection with FIG. 1. The UE 1002 includes a processor 1003 that controls operation of the UE 1002. The processor 1003 may also be referred to as a central processing unit (CPU). Memory 1005, which may include read-only memory (ROM), random access memory (RAM), a combination of the two or any type of device that may store information, provides instructions 1007a and data 1009a to the processor 1003. A portion of the memory 1005 may also include non-volatile random access memory (NVRAM). Instructions 1007b and data 1009b may also reside in the processor 1003. Instructions 1007b and/or data 1009b loaded into the processor 1003 may also include instructions 1007a and/or data 1009a from memory 1005 that were loaded for execution or processing by the processor 1003. The instructions 1007b may be executed by the processor 1003 to implement the methods described herein.

The UE 1002 may also include a housing that contains one or more transmitters 1058 and one or more receivers 1020 to allow transmission and reception of data. The transmitter(s) 1058 and receiver(s) 1020 may be combined into one or more transceivers 1018. One or more antennas 1022a-n are attached to the housing and electrically coupled to the transceiver 1018.

The various components of the UE 1002 are coupled together by a bus system 1011, which may include a power bus, a control signal bus and a status signal bus, in addition to a data bus. However, for the sake of clarity, the various buses are illustrated in FIG. 19 as the bus system 1011. The UE 1002 may also include a digital signal processor (DSP) 1013 for use in processing signals. The UE 1002 may also include a communications interface 1015 that provides user access to the functions of the UE 1002. The UE 1002 illustrated in FIG. 19 is a functional block diagram rather than a listing of specific components.

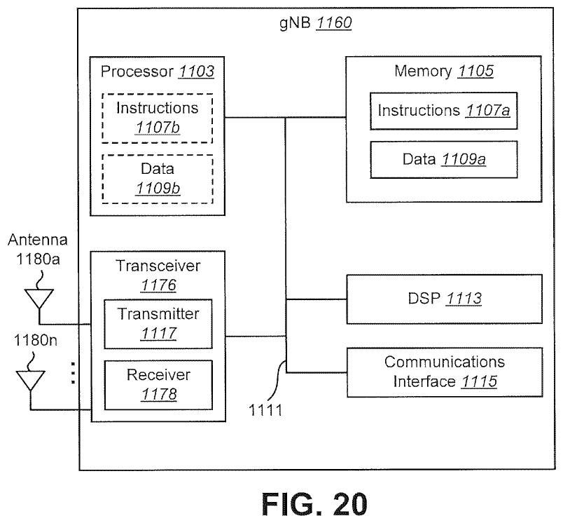

FIG. 20 illustrates various components that may be utilized in a gNB 1160. The gNB 1160 described in connection with FIG. 20 may be implemented in accordance with the gNB 160 described in connection with FIG. 1. The gNB 1160 includes a processor 1103 that controls operation of the gNB 1160. The processor 1103 may also be referred to as a central processing unit (CPU). Memory 1105, which may include read-only memory (ROM), random access memory (RAM), a combination of the two or any type of device that may store information, provides instructions 1107a and data 1109a to the processor 1103. A portion of the memory 1105 may also include nonvolatile random access memory (NVRAM). Instructions 1107b and data 1109b may also reside in the processor 1103. Instructions 1107b and/or data 1109b loaded into the processor 1103 may also include instructions 1107a and/or data 1109a from memory 1105 that were loaded for execution or processing by the processor 1103. The instructions 1107b may be executed by the processor 1103 to implement the methods described herein.

The gNB 1160 may also include a housing that contains one or more transmitters 1117 and one or more receivers 1178 to allow transmission and reception of data. The transmitter(s) 1117 and receiver(s) 1178 may be combined into one or more transceivers 1176. One or more antennas 1180a-n are attached to the housing and electrically coupled to the transceiver 1176.

The various components of the gNB 1160 are coupled together by a bus system 1111, which may include a power bus, a control signal bus and a status signal bus, in addition to a data bus. However, for the sake of clarity, the various buses are illustrated in FIG. 20 as the bus system 1111. The gNB 1160 may also include a digital signal processor (DSP) 1113 for use in processing signals. The gNB 1160 may also include a communications interface 1115 that provides user access to the functions of the gNB 1160. The gNB 1160 illustrated in FIG. 20 is a functional block diagram rather than a listing of specific components.

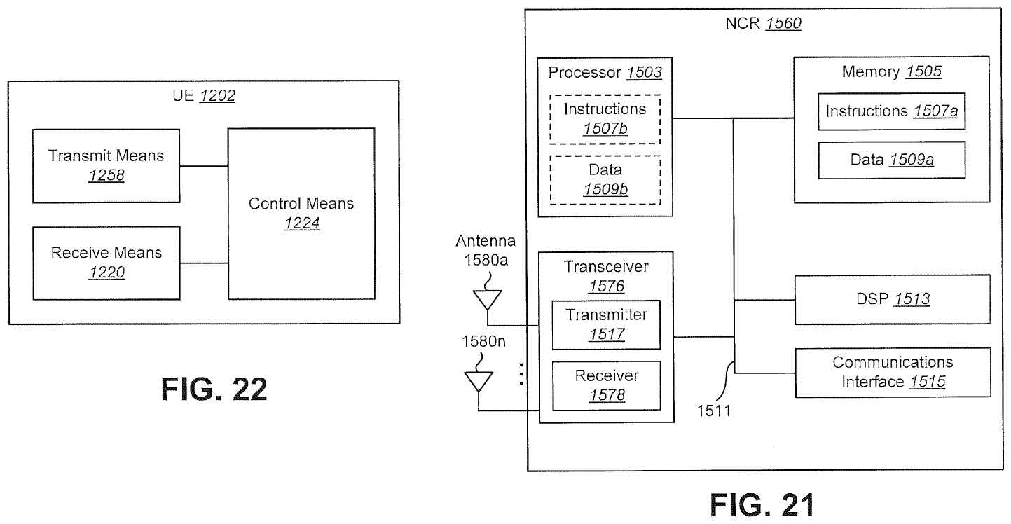

FIG. 21 illustrates various components that may be utilized in a NCR 1560. The NCR 1560 described in connection with FIG. 21 may be implemented in accordance with the NCR described in connection with FIGS. 5-12. The NCR 1560 includes a processor 1503 that controls operation of the NCR 1560. The processor 1503 may also be referred to as a central processing unit (CPU). Memory 1505, which may include read-only memory (ROM), random access memory (RAM), a combination of the two or any type of device that may store information, provides instructions 1507a and data 1509a to the processor 1503. A portion of the memory 1505 may also include nonvolatile random access memory (NVRAM). Instructions 1507b and data 1509b may also reside in the processor 1503. Instructions 1507b and/or data 1509b loaded into the processor 1503 may also include instructions 1507a and/or data 1509a from memory 1505 that were loaded for execution or processing by the processor 1503. The instructions 1507b may be executed by the processor 1503 to implement the methods described herein.

The NCR 1560 may also include a housing that contains one or more transmitters 1517 and one or more receivers 1578 to allow transmission and reception of data. The transmitter(s) 1517 and receiver(s) 1578 may be combined into one or more transceivers 1576. One or more antennas 1580a-n are attached to the housing and electrically coupled to the transceiver 1576.

The various components of the NCR 1560 are coupled together by a bus system 1511, which may include a power bus, a control signal bus and a status signal bus, in addition to a data bus. However, for the sake of clarity, the various buses are illustrated in FIG. 21 as the bus system 1511. The NCR 1560 may also include a digital signal processor (DSP) 1513 for use in processing signals. The NCR 1560 may also include a communications interface 1515 that provides user access to the functions of the NCR 1560. The NCR 1560 illustrated in FIG. 21 is a functional block diagram rather than a listing of specific components.

FIG. 22 is a block diagram illustrating one implementation of a UE 1202 in which one or more of the systems and/or methods described herein may be implemented. The UE 1202 includes transmit means 1258, receive means 1220 and control means 1224. The transmit means 1258, receive means 1220 and control means 1224 may be configured to perform one or more of the functions described in connection with FIG. 1 above. FIG. 19 above illustrates one example of a concrete apparatus structure of FIG. 22. Other various structures may be implemented to realize one or more of the functions of FIG. 1. For example, a DSP may be realized by software.

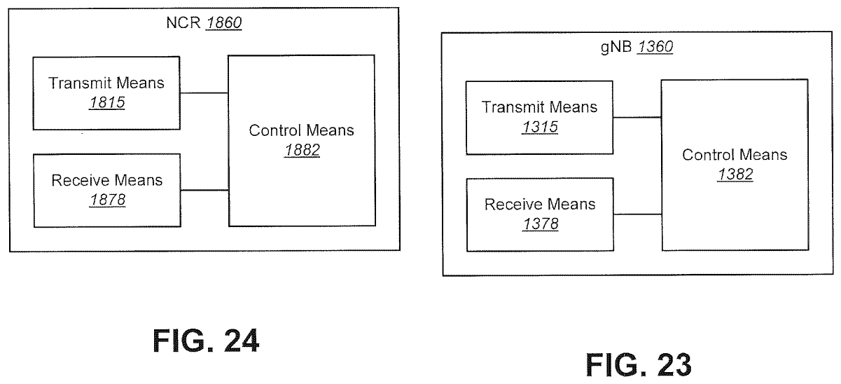

FIG. 23 is a block diagram illustrating one implementation of a gNB 1360 in which one or more of the systems and/or methods described herein may be implemented. The gNB 1360 includes transmit means 1315, receive means 1378 and control means 1382. The transmit means 1315, receive means 1378 and control means 1382 may be configured to perform one or more of the functions described in connection with FIG. 1 above. FIG. 20 above illustrates one example of a concrete apparatus structure of FIG. 23. Other various structures may be implemented to realize one or more of the functions of FIG. 1. For example, a DSP may be realized by software.

FIG. 24 is a block diagram illustrating one implementation of an NCR 1860 in which one or more of the systems and/or methods described herein may be implemented. The NCR 1860 includes transmit means 1815, receive means 1878 and control means 1882. The transmit means 1815, receive means 1878 and control means 1882 may be configured to perform one or more of the functions described in connection with FIGS. 5-12 above. FIG. 21 above illustrates one example of a concrete apparatus structure of FIG. 24. Other various structures may be implemented to realize one or more of the functions of FIG. 1. For example, a DSP may be realized by software.

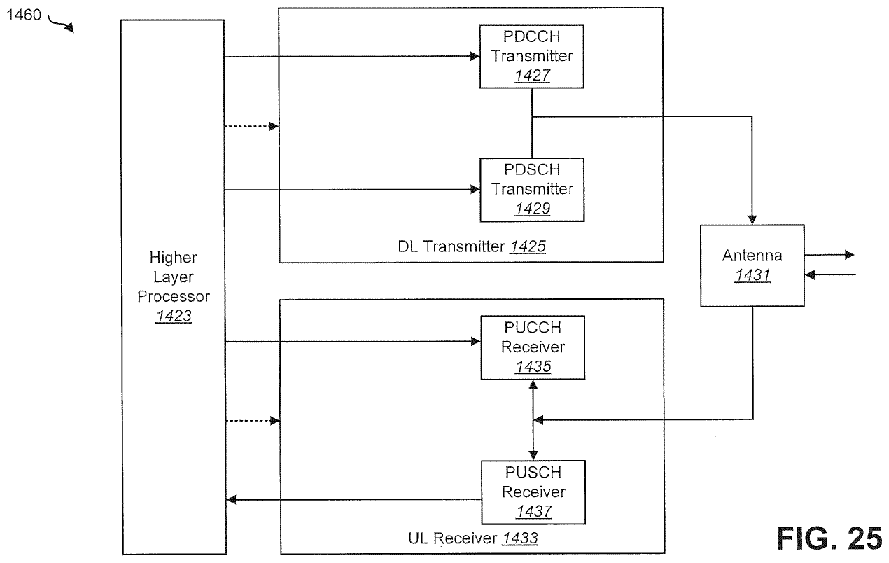

FIG. 25 is a block diagram illustrating one implementation of a gNB 1460. The gNB 1460 may be an example of the gNB 160 described in connection with FIG. 1. The gNB 1460 may include a higher layer processor 1423, a DL transmitter 1425, a UL receiver 1433, and one or more antenna 1431. The DL transmitter 1425 may include a PDCCH transmitter 1427 and a PDSCH transmitter 1429. The UL receiver 1433 may include a PUCCH receiver 1435 and a PUSCH receiver 1437.

The higher layer processor 1423 may manage physical layer's behaviors (the DL transmitter's and the UL receiver's behaviors) and provide higher layer parameters to the physical layer. The higher layer processor 1423 may obtain transport blocks from the physical layer. The higher layer processor 1423 may send/acquire higher layer messages such as an RRC message and MAC message to/from a UE's higher layer. The higher layer processor 1423 may provide the PDSCH transmitter transport blocks and provide the PDCCH transmitter transmission parameters related to the transport blocks.

The DL transmitter 1425 may multiplex downlink physical channels and downlink physical signals (including reservation signal) and transmit them via transmission antennas 1431. The UL receiver 1433 may receive multiplexed uplink physical channels and uplink physical signals via receiving antennas 1431 and de-multiplex them. The PUCCH receiver 1435 may provide the higher layer processor 1423 UCI. The PUSCH receiver 1437 may provide the higher layer processor 1423 received transport blocks.

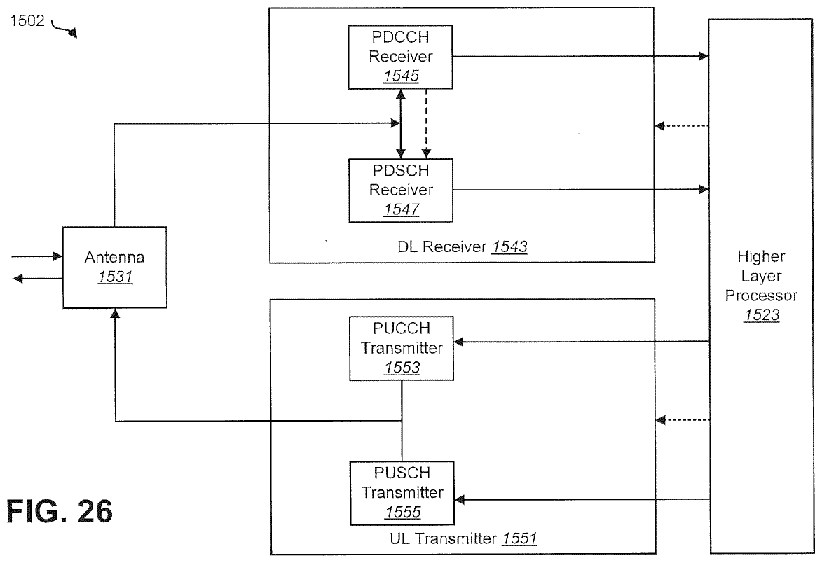

FIG. 26 is a block diagram illustrating one implementation of a UE 1502. The UE 1502 may be an example of the UE 102 described in connection with FIG. 1. The UE 1502 may include a higher layer processor 1523, a UL transmitter 1551, a DL receiver 1543, and one or more antenna 1531. The UL transmitter 1551 may include a PUCCH transmitter 1553 and a PUSCH transmitter 1555. The DL receiver 1543 may include a PDCCH receiver 1545 and a PDSCH receiver 1547.

The higher layer processor 1523 may manage physical layer's behaviors (the UL transmitter's and the DL receiver's behaviors) and provide higher layer parameters to the physical layer. The higher layer processor 1523 may obtain transport blocks from the physical layer. The higher layer processor 1523 may send/acquire higher layer messages such as an RRC message and MAC message to/from a UE's higher layer. The higher layer processor 1523 may provide the PUSCH transmitter transport blocks and provide the PUCCH transmitter 1553 UCI.

The DL receiver 1543 may receive multiplexed downlink physical channels and downlink physical signals via receiving antennas 1531 and de-multiplex them. The PDCCH receiver 1545 may provide the higher layer processor 1523 DCI. The PDSCH receiver 1547 may provide the higher layer processor 1523 received transport blocks.

The term “computer-readable medium” refers to any available medium that can be accessed by a computer or a processor. The term “computer-readable medium,” as used herein, may denote a computer- and/or processor-readable medium that is non-transitory and tangible. By way of example and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD and the like), a magnetic storage medium (for example, a magnetic tape, a flexible disk and the like) and the like, any one may be possible. Furthermore, in some cases, the function according to the described systems and methods described herein is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described herein may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described herein may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

### CROSS REFERENCE

This Nonprovisional application claims priority under 35 U.S.C. § 119 on provisional Application No. 63/388,192 on Jul. 11, 2022, the entire contents of which are hereby incorporated by reference.

What is claimed is:

1. A network controlled repeater (NCR) comprising:
receiving circuitry configured to:
detect and receive system information including synchronization signal block (SSB) configuration from a gNodeB (gNB);
receive side information with NCR SSB forwarding timing from the gNB;
receive side information on SSB positions for NCR SSB transmissions;
transmitting circuitry configured to:
determine the SSB positions for NCR SSB transmission;
regenerate the SSB with NCR SSB indexes;
transmit the SSBs in the determined SSB positions with corresponding NCR beams, and not transmit in the remaining SSB positions in the synchronization signal (SS) burst set.

2. The NCR of claim 1, wherein the forwarding timing is 5 milliseconds (ms) or is provided by the side information with a parameter of a number of slots.

3. The NCR of claim 1, wherein the SSB positions for NCR SSB transmission is determined by the NCR beam indexes.

4. The NCR of claim 1, wherein the SSB positions for NCR SSB transmission is determined by a configured pattern with dedicated SSB positions in burst for NCR, or an on/off bitmap pattern for NCR.

5. A gNodeB (gNB) comprising:
transmitting circuitry configured to:
transmit side information on synchronization signal block (SSB) forwarding timing to a network controlled repeater (NCR);
transmit side information on SSB positions for an NCR SSB transmission to the NCR;
receiving circuitry configured to:
receive a beam report based on an SSB index from a User Equipment (UE);
determine an NCR beam index based on the received SSB index from the UE.

6. The gNB of claim 5, wherein the side information includes a configured pattern with dedicated SSB positions in burst for NCR, or an on/off bitmap pattern for NCR
includes a number of beams for the NCR SSB reception.

7. The gNB of claim 6, wherein if the configured pattern with dedicated SSB positions in burst for NCR, or the on/off bitmap pattern for NCR is configured, the gNB determines the NCR beam index based on the configured pattern.

8. A communication method of a network controlled repeater (NCR), comprising:
detecting and receiving system information including synchronization signal block (SSB) configuration from a gNodeB (gNB);
receiving side information with an NCR SSB forwarding timing from the gNB;
receiving side information on SSB positions for NCR SSB transmissions;
determining the SSB positions for NCR SSB transmission;
regenerating the SSB with NCR SSB indexes;
transmitting the SSBs in the determined SSB positions with corresponding NCR beams, and not transmitting in the remaining SSB positions in the synchronization signal (SS) burst set.
